(19) United States
(12) Patent Application Publication
(10) Pub. No.: US 2026/0268198 A1
(43) Pub. Date: Sep. 10, 2026

(54) AUTONOMOUS QUANTUM ERROR CORRECTION FOR SQUEEZED CAT CODES

(71) Applicant: The University of Chicago, Chicago, IL (US)

(72) Inventors: Qian XU, Chicago, IL (US); Guo ZHENG, Chicago, IL (US); Yuxin WANG, Chicago, IL (US); Aashish CLERK, Chicago, IL (US); Liang JIANG, Chicago, IL (US)

(21) Appl. No.: 19/021,868

(22) Filed: Jan. 15, 2025

Related U.S. Application Data
(63) Continuation of application No. PCT/US2023/027728, filed on Jul. 14, 2023.
(60) Provisional application No. 63/389,544, filed on Jul. 15, 2022.

(51) Int. Cl. G06N 10/70; G06N 10/20

(52) U.S. Cl. CPC G06N 10/70; G06N 10/20

(57) ABSTRACT

The present disclosure describes various methods, systems, and storage medium for performing a quantum operation on a qubit using an autonomous quantum error correction scheme. One method includes obtaining the qubit comprising a squeezed cat (SC) qubit encoded with quantum information; concatenating the qubit with a set of codes; engineering a dissipation corresponding to the concatenated qubit; and applying, according to the engineered dissipation, quantum error correction on the concatenated qubit to perform error correction on the encoded quantum information.

### RELATED APPLICATIONS

This application is a continuation application of PCT International Patent Application No. PCT/US2023/027728, filed on Jul. 14, 2023, which is herein incorporated by reference in its entirety. PCT International Patent Application No. PCT/US2023/027728 is based on and claims the benefit of priority to U.S. Provisional Application No. 63/389,544 filed on Jul. 15, 2022, which is herein incorporated by reference in its entirety.

### GOVERNMENT LICENSE RIGHTS

This invention was made with government support under FA9550-21-1-0209, and FA9550-19-1-0399 awarded by the Air Force Office of Scientific Research, W911NF-19-1-0380, W911NF-18-1-0020, W911NF-21-1-0325, W911NF-18-1-0212, and W911NF-16-1-0349 awarded by the Army Research Laboratory-Army Research Office, and OMA1936118, OMA2137642, and EEC1941583 awarded by the National Science Foundation. The government has certain rights in the invention.

### FIELD OF THE INVENTION

This disclosure relates to a method and system for performing autonomous quantum error correction for squeezed cat codes for quantum computing, quantum information processing, and quantum storage.

### BACKGROUND OF THE INVENTION

Quantum information is fragile to errors introduced by the environment. Quantum error correction (QEC) protects quantum systems by correcting the errors and removing the entropy. Based upon QEC, fault-tolerant quantum computation (FTQC) can be performed, provided that the physical noise strength is below an accuracy threshold. However, realizing FTQC is yet challenging due to the demanding threshold requirement and the significant resource overhead.

The present disclosure describes various embodiments for performing autonomous quantum error correction for squeezed cat codes for quantum computing, quantum information processing, and quantum storage, addressing at least some of the problems/issues associated with the previous schemes, achieving fast and high-fidelity gate operations, and improving the technology field of quantum computer and information processing.

### SUMMARY OF THE INVENTION

In view of this, embodiments of the present disclosure are expected to provide a method, apparatus, and a storage medium for performing a quantum operation on a qubit using an autonomous quantum error correction scheme.

According to one aspect, an embodiment of the present disclosure provides a method for performing a quantum operation on a qubit using an autonomous quantum error correction scheme. The method includes obtaining the qubit comprising a squeezed cat (SC) qubit encoded with quantum information; concatenating the qubit with a set of codes; engineering a dissipation corresponding to the concatenated qubit; and applying, according to the engineered dissipation, quantum error correction on the concatenated qubit to perform error correction on the encoded quantum information performing fast bias-preserving gate operations and stabilizing cat qubits.

An apparatus for performing quantum computing, the apparatus comprising a first device storing a qubit and a second device performing an operation on the qubit, wherein the apparatus is configured to perform a portion or all of the above methods.

An apparatus for storing quantum information, the apparatus comprising a first device storing a qubit and a second device performing an operation on the qubit, wherein the apparatus is configured to perform a portion or all of the above methods.

A non-transitory computer program product comprising a computer-readable program medium code stored thereupon, the computer-readable program medium code, when executed by a processor, causing the processor to perform a portion or all of the above methods.

The above and other aspects and their implementations are described in greater detail in the drawings, the descriptions, and the claims.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The system, device, product, and/or method described in the present disclosure may be better understood with reference to the following drawings and description of non-limiting and non-exhaustive embodiments. The components in the drawings are not necessarily to scale, and reference is made to the following drawings, in which:

FIG. 1 is a flow diagram of an embodiment disclosed in the present disclosure;

FIG. 2 is a schematic diagram of an embodiment of an apparatus disclosed in the present disclosure;

FIG. 3 illustrates a schematic diagram of a classical computer system;

FIG. 4 illustrates a schematic diagram of a quantum computer system;

FIG. 5 shows a schematic diagram of various embodiments in the present disclosure. The illustration of a SC that suffers from a single excitation loss and then approximately corrects it. Each dashed box represents a state (visualized by the Wigner function) of the SC, which is decomposed as a product of a logical qubit and a gauge mode. A single excitation loss corrupts the codeword |+ [symbol] _{c} (left) into the state â|+ [symbol] _{c}/ [symbol] (right). During such a process, a phase flip happens on the logical qubit, and a fraction 1−η of the gauge mode population gets excited (indicated by the thick orange arrow). The excited population can be detected and then corrected, as indicated by the blue arrow;

FIG. 6 shows a schematic diagram of various embodiments in the present disclosure. (a) The phase γ_{Z} (orange) and bit γ_{X,Y} (cyan) error rate of the dissipatively stabilized SC as a function of squeezing r under the parameters n̅=4, κ₁=100κ_{φ}=κ₂/100, nₜₕ=0.01. The solid lines represent the analytical expressions Eqs. (10) and (11) while the diamonds represent the numerically extracted values. All the error rates are normalized by those of the dissipative cat γ_{Z,c}, (γ_{X,Y})_{c}, which are given by Eqs. (10) and (11) with r=0. (b) The entanglement infidelity of a joint loss and recovery channel varying with the loss probability γ for the SC encoding with n̅=4. The recovery channel is either the engineered dissipation (the circles) or the optimal recovery channel determined by an SDP program (the stars);

FIG. 7 shows charts of various embodiments in the present disclosure. The total Z error probability of the Z(π) gates (a) and the CX gates (b) as a function of the gate time. For the CX gate, p_{Z}:=p_{Z}_{_{c}}+p_{Z}_{ₜ}+p_{Z}_{_{c}}_{Z}_{ₜ} is the sum of the control-mode, target-mode, and the correlated phase flip rates. κ₁/κ₂ is fixed at 10⁻³. The blue lines represent the gates on the cat qubits, and the red lines represent our proposed gates on the SC qubits with η=¼. n̅ is chosen as 4 for both cat and SC. The insets are the zoomed-in error rates of the SC gates around the optimal gate times. As detailed in Methods, the Z(π) gate requires a linear drive of strength

$$\frac{π}{8 T} ( \frac{π}{4 T} )$$

for the cat (SC). The CX gate requires a nonlinear coupling between the control and the target mode of strength

$$\frac{π}{8 T} ( \frac{π}{4 T} )$$

### for the cat (SC);

FIG. 8 shows charts of various embodiments in the present disclosure. Logical errors of the SC and the cat concatenated with repetition codes or surface codes. (a) Surface code logical Z error probabilities for a range of code distance d_{Z}=3, 5, 7, . . . , 15 (from red to brown) with fixed d_{X}=3. The SC is fixed to n̅=4, η=¼. The dashed lines indicate the threshold values of κ₁/κ₂. (b) Surface code thresholds in κ₁/κ₂ varying with the average excitation number of the SC or the cat. (c) Repetition code logical Z error probabilities for a range of code size d_{Z}. (d) Repetition code minimum total logical error probabilities, under the long gate time constraint T≥1/κ₂. Both the cat and the SC have an average excitation number n̅=4. The logical error probabilities for both the surface codes and the repetition codes are obtained from Monte Carlo simulations of d_{Z} code cycles and one final round of perfect stabilizer measurement. A same minimum-weight-perfect-matching (MWPM) decoder may be used;

FIG. 9 shows a schematic diagram of various embodiments in the present disclosure. (a) Realization of the parity-flipping dissipator \hat{Z}_{L}⊗\tilde{â} using three nonlinearly coupled bosonic modes. (b) Comparison between the numerically extracted η (ηₛᵢₘ) and the theoretically predicted η (η_{pred} in Eq. (6)) for a range of finite Γₐ/Γ_{b}. The dashed line indicates the ideal case where ηₛᵢₘ=η_{pred};

FIG. 10 shows schematic diagrams of various embodiments in the present disclosure. Laser configuration for the coupling Hamiltonian in Eq. (22) for implementing the SC in trapped-ion system. The motional mode of the ion is coupled to three internal states via the sideband transitions, represented by the black and the green arrows. Starting from |g [symbol] ⊗|ψ [symbol] is an arbitrary motional state), the system goes through a two-step coherent transition |g [symbol] ⊗|ψ [symbol] →|f [symbol] ⊗\hat{F}₁|ψ [symbol] →|e [symbol] ⊗\hat{F}₂\hat{F}₁|ψ [symbol] (indicated by the black and the green solid arrows, respectively) and decays rapidly to |g [symbol] ⊗\hat{F}₂\hat{F}₁|ψ [symbol] (indicated by the black dashed arrows). Here \hat{F}₁∝Ŝ(r)(â²−α′²)Ŝ^{†}(r) and \hat{F}₂∝Ŝ(r)âŜ^{†}(r). Adiabatically eliminating the |e [symbol] , |f [symbol] states, we obtain the effective dissipator on the motional mode \hat{F}=\hat{F}₂\hat{F}₁;

FIG. 11 shows charts of various embodiments in the present disclosure. Relations between the displacement, α′, and the average photon number, n̅, as a function of the exponential of squeezing, e^{2r}, of a SC code, |SC_{α′,r} [symbol] . (a) The displacement varies with the squeezing as α′=\sqrt{n̅−sin h²re}² while fixing the average photon numbers. The maximum achievable displacements are \sqrt{n̅²+n̅}. (b) The average photon number varies with the squeezing as n̅=α′²e^{-2r}+sin h² r while fixing the displacements and, therefore, the dissipation gap; and

FIG. 12 shows a schematic diagram of various embodiments in the present disclosure. The absolute value of the process matrix χ for a SC stabilized by κ₂ [symbol] \hat{Z}_{L}Ŝ(r)(â²−α′²) Ŝ^{†}(r)] with n̅=4, r=0.2 under κ₁=10κ₂/100, nₜₕ=0.02 for a time T=5/κ₂.

### DETAILED DESCRIPTION

The description and accompanying drawings above provide specific example embodiments and implementations. Drawings containing device structure and composition, for example, are not necessarily drawn to scale unless specifically indicated. Subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, or systems. Accordingly, embodiments may, for example, take the form of hardware, software, firmware or any combination thereof.

Throughout the specification and claims, terms may have nuanced meanings suggested or implied in context beyond an explicitly stated meaning. Likewise, the phrase “in one embodiment/implementation” as used herein does not necessarily refer to the same embodiment and the phrase “in another embodiment/implementation” as used herein does not necessarily refer to a different embodiment. It is intended, for example, that claimed subject matter includes combinations of example embodiments in whole or in part.

Unless defined otherwise, all technical and scientific terms used herein have the same meaning as commonly understood by one of skill in the art to which the invention pertains. Although any methods and materials similar to or equivalent to those described herein can be used in the practice or testing of the present invention, the preferred methods and materials are described herein.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The embodiments of the present disclosure provide a method, an apparatus, and a non-transitory computer readable storage medium for performing autonomous quantum error correction for squeezed cat codes for quantum computing, quantum information processing, and quantum storage. In the present disclosure, the cat codes may be referred as cat quantum bits (qubits); or visa versa.

Quantum computing and quantum information processing may potentially solve practical problems in a range of areas, which may not be realistically solvable by classical computing on classical computers alone. Quantum computing and quantum information process may need at least two building blocks: a device to initialize, maintain, stabilize, or establish at least one qubit; and a set of quantum gates to perform quantum operations on one or more qubits to obtain one or more modified qubits. However, qubits and/or quantum gates may be prone to unintended interference/decoherence from outer environment and/or imperfection in the device. For example, quantum gates are prone to errors, which may significantly lower the quality or fidelity of quantum gates.

Some quantum errors in general quantum information processing may be correctable using quantum error correction (QEC) techniques. In some implementations, QEC codes may be tailored towards biased quantum noise to exhibit higher error threshold. As such, noise bias may be critical for some QEC techniques. In some implementations, multi-component cat qubits may possess noise bias channels and thus may be considered as a platform for implementation of these QEC codes. These multi-component cat qubit may be a Schrodinger Cat qubit (or simply cat qubit) including coherent quantum superposition of a plurality of quantum states in a quantum mechanical subspace. More detailed description on cat qubit is included in PCT Application No. PCT/US2022/012490, filed on Jan. 14, 2022, by the same Applicant as the present application, which is incorporated herein by reference in its entirety.

In some implementation, a cat qubit may be squeezed by applying a squeezing operation along a displacement axis, so as to obtain a squeezed cat code/qubit (SCC). The present disclosure describes various embodiments for constructing and/or performing a quantum information computing/processing scheme, wherein autonomous quantum error correction (AutoQEC) is applied on squeezed cat codes (SCCs).

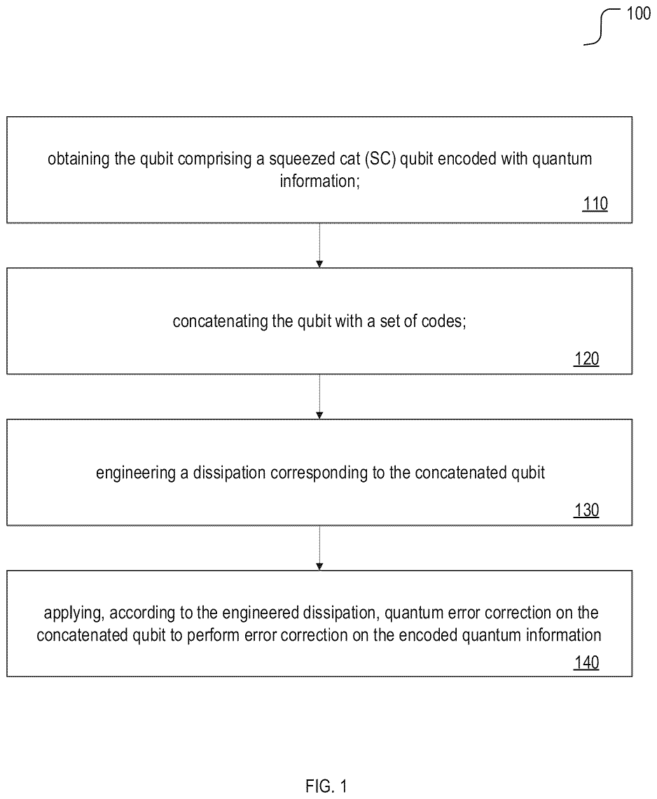

Referring to FIG. 1, various embodiments in the present disclosure may include a method 100 for performing a quantum operation on a qubit using an autonomous quantum error correction scheme. The method 100 may include a portion or all of the following steps: step 110, obtaining the qubit comprising a squeezed cat (SC) qubit encoded with quantum information; step 120, concatenating the qubit with a set of codes; step 130, engineering a dissipation corresponding to the concatenated qubit; and step 140, applying, according to the engineered dissipation, quantum error correction on the concatenated qubit to perform error correction on the encoded quantum information.

Various embodiments in the present disclosure may efficiently suppress excitation loss and dephasing errors, by stabilizing the encoded quantum information in the logical subspace of squeezed cat code, enabling better suppression of logical dephasing error due to excitation loss, while maintaining the favorable exponential suppression of logical bit-flip error. Various embodiments described in the present disclosure, in comparation to some other implementations with applying AutoQEC with cat codes, address some issues/problems in other implementations, achieving better performance with a much smaller average photon number for encoding and more favorable experimental control parameters.

Various embodiments in the present disclosure may reduce the overhead for QEC. In some implementation, the overhead may be related to a ratio of good dissipations over bad dissipations. To perform QEC, the ratio may be within a ratio threshold, which may be reduced by a factor of 10, e.g., the ratio threshold may be reduced from 1000 to 100, wherein the ratio threshold may be referred as a dissipation ratio threshold. The good dissipations may include engineered dissipation, and/or the bad dissipations may include the photon loss dissipation. When the implementations based on SC may have a smaller dissipation ratio threshold, i.e., in response to the good dissipations being the same or does not differ substantially, the implementations based on SC may tolerate a larger bad dissipation rate.

The present disclosure also describes various embodiments with experimental design to implement desired engineered dissipation with corresponding AutoQEC on SCCs.

In some implementations, a degree of the squeezing on the cat code may be quantified by a squeezing parameter, and the squeezing parameter may be a non-negative real number. The smaller the squeezing parameter is, the less of the squeezing operation on the cat code is, for example, when the squeezing parameter is zero, it means there is no squeezing, which refers to a normal cat code.

In some implementations, in comparison to the cat code or some other schemes, the SCC may have a smaller average photon number. When the squeezing of the SCC increases, the average photon number may decrease. A smaller average photon number with a reduced photon loss rate may be beneficial for quantum information computing/processing.

In some implementations, in comparison to the cat code or some other schemes, the SCC may allow the correction of quantum errors due to photon loss, resulting in the recovery of the encoded quantum information. In some implementation, an engineering dissipation operation may be constructed to operate on the SCC to correct the photon loss error.

In some implementations, in comparison to the cat code or some other schemes, the SCC may have a larger dissipative gap, which is beneficial for protecting the encoded quantum information from dephasing error or excitation loss. The dissipative gap of the SCC may have a quadratic scale with respect to the average photon number, and in some implementations, the dissipative gap of the cat code may have a linear scale with respect to the average photon number.

In some implementations, at least one of the following may be suppressed to protect the encoded quantum information: dephasing error (or phase-flip error), and/or bit-flip error. The bit-flip error rate and/or the phase-flip error rate (per operation) may depend on the squeezing parameter. The bit-flip error rate's dependence on the squeezing parameter may not be monotonical, for example, there may be an optimized squeezing parameter that a minimum bit-flip error rate is achieved. The dephasing error rate's dependence on the squeezing parameter may be monotonical, for example, the dephasing error rate may decrease as the squeezing parameter increases. In some implementations, a squeezing parameter may be determined to optimize a total error effect due to the phase-flip error rate and the bit-flip error rate. The determined squeezing parameter may be referred as an optimized squeezing parameter. In some implementations, a next level error correction scheme may be introduced to further suppress (or reduce) the dephasing error.

In some implementations, in comparison to the cat code or some other schemes, the SCC may have a larger dissipative gap, allowing faster quantum gate operation and achieving better protection to the encoded quantum information with respect to errors.

In some implementations, an autonomous quantum error corrections (auto-QEC) is applied on the SC against quantum loss errors by engineering a dissipation, which may simultaneously stabilize the SC and correct the loss errors. The engineered dissipation may be referred as good dissipation and have an engineered dissipation rate, which works with other bad dissipation rate (e.g., due to excitation loss and/or dephasing loss) to construct the dissipation ratio.

In some implementations, quantum error corrections may be performed when the SC is concatenated with another code, suppressing logical error rates to a desired level, which may be referred as concatenated quantum error correction. The “another” code may be an outer discrete-variable code, including, for example, a thin rotated surface code and/or a repetition code. In some implementations, the SC concatenated with a repetition code (e.g., referred as repetition-SC) may be used only to suppress dephasing error, resulting in that the repetition-SC may not arbitrarily suppress the errors for a cat with constrained averaged photon number. The repetition-SC alone may be sufficient for practical application; and in a quantum computation with long durations, the repetition code and surface code may be used together to achieve the desired error-suppression level.

The present disclosure describes various embodiments for physical realization of the autoQED for SC. A jump operator, which is applies on SC corresponding to a change of its quantum state, may be physically realized using accessible experimental resources, for non-limiting example, superconducting circuits, trapped-ion system, photonic quantum system, electron state in doped semiconductor (e.g., silicon), and the like. A Lindblad dissipator may be build upon the jump operator in the experimental resources, for example, the non-linear dissipator may be realized with three nonlinearly-coupled bosonic modes in superconducting circuits, and/or the non-linear dissipator may be realized with coupling a bosonic mode nonlinearly to a qutrit in trapped-ion systems. The non-linear dissipator may be used in a master equation, which is a partial differential equation to govern the dynamics of the SC states. In some implementation with trapped-ion system, the quantum information may be encoded with motional states of the trapped-ion.

The method 100 may be performed by any suitable quantum computing quantum information processing architecture with a quantum information processor, and may not depend on the underlying architecture of the quantum information processor. The quantum information processor may be any suitable quantum computing architecture that may perform universal quantum computation or quantum information processing, for example, a set of quantum gate operations. In some implementations, examples of quantum computing architecture may include superconducting qubits, ion traps and optical quantum computer. A classical analog of quantum processor is a central processing unit (CPU) in a classical computer. In some implementations, the method 100 may be performed by any suitable quantum memory devices for storing one or more qubit, and may not depend on the underlying physical architecture of the quantum memory device.

In various embodiments in the present disclosure, a system may include a quantum computing portion and a classical computing portion in communication with the quantum computing portion. The quantum computing portion may perform a portion or all of the method 100; and/or the classical computing portion may perform other computation and/or provide interface between a user and the quantum computing portion.

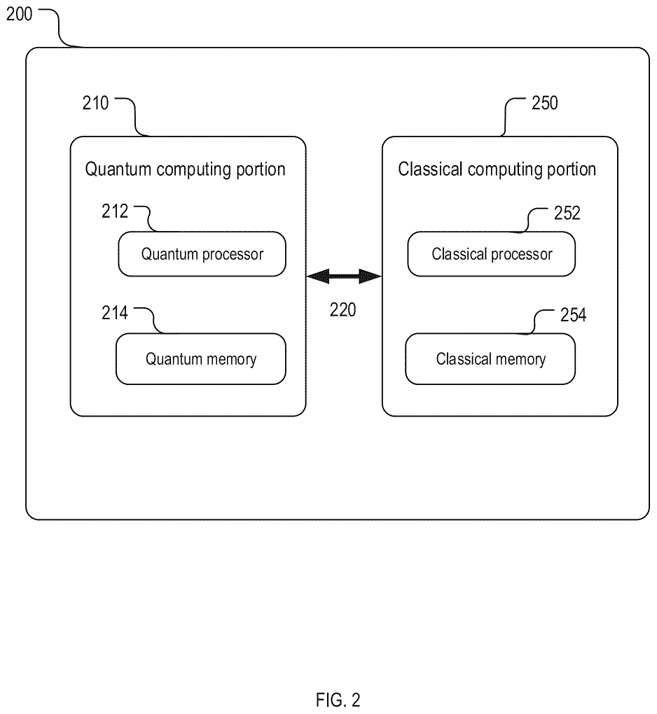

FIG. 2 shows an embodiment of a system 200 including a quantum computing portion 210 and a classical computing portion 250. The quantum computing portion 210 may include a quantum information processor 212 and the classical computing portion 250 may include a classical processor 252. Optionally, the quantum computing portion 210 may include a quantum memory 214. The quantum processor 212 and/or the quantum memory 214 may be realized by a same type or different types of quantum platforms, for example but not limited to superconducting circuits, trap ions, optical lattices, quantum dots, and linear optics. In one implementation, the classical computing portion 250 may include a classical memory 254. The system 200 may also include an input (not shown in FIG. 2) and an output (not shown in FIG. 2). The input may receive data and/or instructions into the system; and/or after quantum computing, the output may output result from the system 200. The quantum computing portion 210 may communicate with the classical computing portion 250 via an interface 220.

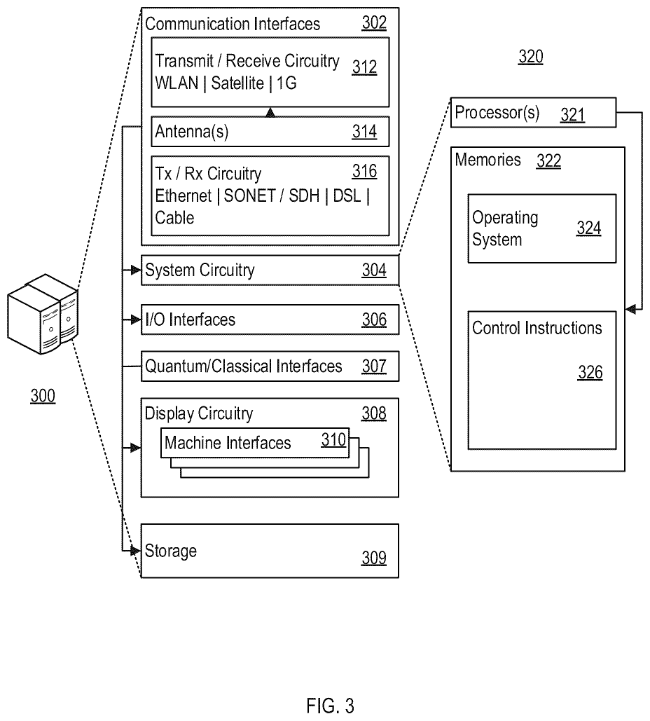

Referring to FIG. 3, in one implementation, a classical computer portion may be a portion of a classical computer system 300. The classical computer system 300 may include communication interfaces 302, system circuitry 304, input/output (I/O) interfaces 306, a quantum-classical interface 307, storage 309, and display circuitry 308 that generates machine interfaces 310 locally or for remote display, e.g., in a web browser running on a local or remote machine. The machine interfaces 310 and the I/O interfaces 306 may include GUIs, touch sensitive displays, voice or facial recognition inputs, buttons, switches, speakers and other user interface elements.

The machine interfaces 310 and the I/O interfaces 306 may further include communication interfaces with sensors and detectors. The communication between the computer system 300 and the sensors and detector may include wired communication or wireless communication. The communication may include but not limited to, a serial communication, a parallel communication; an Ethernet communication, a USB communication, and a general purpose interface bus (GPIB) communication. Additional examples of the I/O interfaces 306 include microphones, video and still image cameras, headset and microphone input/output jacks, Universal Serial Bus (USB) connectors, memory card slots, and other types of inputs. The I/O interfaces 306 may further include magnetic or optical media interfaces (e.g., a CDROM or DVD drive), serial and parallel bus interfaces, and keyboard and mouse interfaces. The quantum-classical interface may include a interface communicating with a quantum computer.

The communication interfaces 302 may include wireless transmitters and receivers (“transceivers”) 312 and any antennas 314 used by the transmitting and receiving circuitry of the transceivers 312. The transceivers 312 and antennas 314 may support Wi-Fi network communications, for instance, under any version of IEEE 802.11, e.g., 802.11n or 802.11ac. The communication interfaces 302 may also include wireline transceivers 316. The wireline transceivers 316 may provide physical layer interfaces for any of a wide range of communication protocols, such as any type of Ethernet, data over cable service interface specification (DOCSIS), digital subscriber line (DSL), Synchronous Optical Network (SONET), or other protocol. In another implementation, the communication interfaces 302 may further include communication interfaces with the sensors and detectors.

The storage 309 may be used to store various initial, intermediate, or final data. In one implementation, the storage 309 of the computer system 300 may be integral with a database server. The storage 309 may be centralized or distributed, and may be local or remote to the computer system 300. For example, the storage 309 may be hosted remotely by a cloud computing service provider.

The system circuitry 304 may include hardware, software, firmware, or other circuitry in any combination. The system circuitry 304 may be implemented, for example, with one or more systems on a chip (SoC), application specific integrated circuits (ASIC), microprocessors, discrete analog and digital circuits, and other circuitry. For example, the system circuitry 304 may include one or more instruction processors 321 and memories 322. The memories 322 stores, for example, control instructions 326 and an operating system 324. In one implementation, the instruction processors 321 execute the control instructions 326 and the operating system 324 to carry out any desired functionality related to the controller.

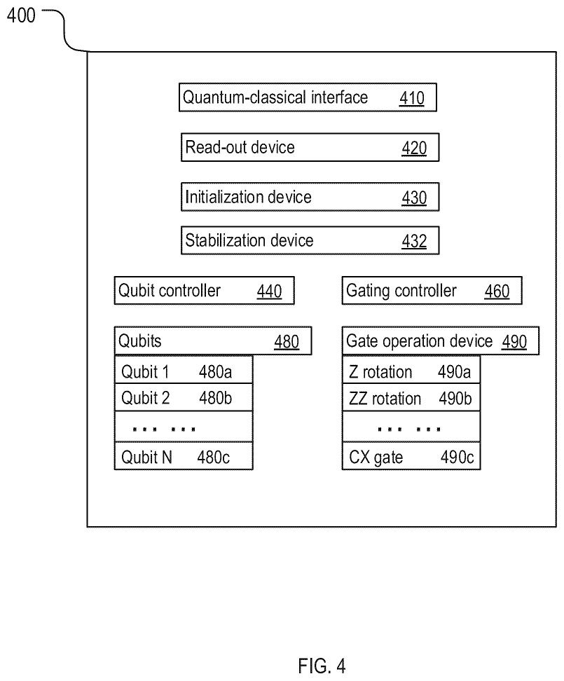

Referring to FIG. 4, in one implementation, a quantum computer portion 210 of FIG. 2 may be an entirety or part of a quantum computer system 400 and may further include components not depicted in FIG. 4. The quantum computer system 400 may include a portion or all of the following: a quantum-classical interface 410, a read-out device 420, an initialization device 430, a stabilization device 432, a qubit controller 440, and a gating controller 460. The quantum-classical interface 410 may provide an interface for communicating with a classical computer. The initialization device 430 may initialize the quantum computer system 400. The quantum computer system 400 may include a form of a quantum processor which includes one or more qubits. For example, the quantum computer system may include a plurality of qubits (qubit 1 480a, qubit 2 480b, . . . , and qubit N 480c, wherein N is a positive integer). The quantum computer system 400 may include a quantum gate operation device, which may perform at least one quantum gate operation, which may include, for example, one or more of of Z rotation gate 490a, ZZ rotation gate 490b, . . . , and controlled-not (CX or CNOT) gate 490c.

Referring to FIG. 1, step 110 may further include applying a squeezing operation on a Schrodinger Cat qubit according to a squeezing parameter to obtain the SC qubit, a Schrodinger Cat qubit comprising coherent quantum superposition of a plurality of quantum states.

In some implementations, the SC qubit has an average photon number corresponding to the squeezing parameter.

In some implementations, the method may further include determining the squeezing parameter as so to maintain a dissipation ratio not being larger than a threshold, the dissipation ratio being a ratio between the engineered dissipation and a photon loss dissipation.

In some implementations, the set of codes comprises at least one outer discrete-variable code.

In some implementations, the outer discrete-variable code comprises at least one surface code or at least one repetition code.

In some implementations, the step of engineering the dissipation corresponding to the concatenated qubit may include engineering the dissipator corresponding to the concatenated qubit based on three nonlinearly-coupled bosonic modes. In some implementations, the three nonlinearly-coupled bosonic modes are within superconducting circuits.

In some implementations, the step of engineering the dissipation corresponding to the concatenated qubit may include engineering the dissipator corresponding to the concatenated qubit based on nonlinearly coupling a bosonic mode to a qutrit. In some implementations, the bosonic mode and the qutrit are in trapped-ion systems.

The present disclosure also describes various embodiment of an apparatus for performing quantum computing. The apparatus includes a first device storing a qubit and a second device performing an operation on the qubit. The apparatus is configured to perform any portion or all of the methods, embodiments, and/or implementations described in the present disclosure.

The present disclosure also describes various embodiment of an apparatus for storing quantum information. The apparatus includes a first device storing a qubit and a second device performing an operation on the qubit. The apparatus is configured to perform any portion or all of the methods, embodiments, and/or implementations described in the present disclosure.

The present disclosure also describes various embodiment of a computer program product comprising a computer-readable program medium code stored thereupon. The computer-readable program medium code, when executed by a processor, causing the processor to implement any portion or all of the methods, embodiments, and/or implementations described in the present disclosure.

The present disclosure describes various embodiments in more details below.

In various embodiments, an autonomous quantum error correction scheme is described using squeezed cat (SC) code against excitation loss in continuous-variable systems. Through reservoir engineering, a structured dissipation can stabilize a two-component SC while autonomously correcting the errors. The implementation of such dissipation only requires low-order nonlinear couplings among three bosonic modes or between a bosonic mode and a qutrit. While some schemes may be device independent, it is readily implementable with current experimental platforms such as superconducting circuits and trapped-ion systems. Compared to the stabilized cat, the stabilized SC has a much lower dominant error rate and a significantly enhanced noise bias. Furthermore, the bias-preserving operations for the SC have much lower error rates. In combination, the stabilized SC leads to substantially better logical performance when concatenating with an outer discrete-variable code. The surface-SC scheme achieves more than one order of magnitude increase in the threshold ratio between the loss rate κ₁ and the engineered dissipation rate κ₂. Under a practical noise ratio κ₁/κ₂=10⁻³, the repetition-SC scheme can reach a 10⁻¹⁵ logical error rate even with a small mean excitation number of 4, which already suffices for practically useful quantum algorithms.

### Introduction

Quantum information is fragile to errors introduced by the environment. Quantum error correction (QEC) protects quantum systems by correcting the errors and removing the entropy. Based upon QEC, fault-tolerant quantum computation (FTQC) can be performed, provided that the physical noise strength is below an accuracy threshold. However, realizing FTQC is yet challenging due to the demanding threshold requirement and the significant resource overhead. Unlike discrete-variable (DV) systems, continuous-variable (CV) systems possess an infinite-dimensional Hilbert space. Encoding the quantum information in CV systems, therefore, provides a hardware-efficient approach to QEC. Various bosonic codes have been experimentally demonstrated to suppress errors in CV systems.

The standard QEC procedure relies on actively measuring the error syndromes and performing feedback controls. However, such adaptive protocols demand fast, high-fidelity coherent operations and measurements, which poses significant experimental challenges. At this stage, the error rates in the encoded level are still higher than the physical error rates in current devices due to the errors during the QEC operations. To address these challenges, QEC may be non-adaptively implemented via engineered dissipation—an approach called autonomous QEC (AutoQEC). Such an approach avoids the measurement imperfection and overhead associated with the classical feedback loops. AutoQEC in bosonic systems that can magnificently suppress the dephasing noise has been both theoretically investigated and experimentally demonstrated using the two-component cat code. However, AutoQEC against excitation loss, which is usually the dominant error source in a bosonic mode, remains challenging. It requires either large nonlinearities that are challenging to engineer (e.g., the multiphoton processes needed for n-fold rotation-symmetrical codes with n≥4) or couplings to an intrinsically nonlinear DV system that is much noisier than the bosonic mode.

The present disclosure describes an AutoQEC scheme against excitation loss with low-order nonlinearities and accessible experimental resources. The scheme is, in principle, device-independent and readily implementable in superconducting circuits and trapped-ion systems. The scheme is based on the squeezed cat (SC) encoding, which involves the superposition of squeezed coherent state. An explicit AutoQEC scheme is described for the SC against loss errors by engineering a nontrivial dissipation, which simultaneously stabilizes the SC states and corrects the loss errors. The engineered dissipation is close to the optimal recovery obtained using a semidefinite programming. Notably, the dissipation can be implemented with the same order of nonlinearity as that required by the two-component cat, which can be experimentally demonstrated in superconducting circuits and shown to be feasible in trapped-ion systems.

The present disclosure shows that similar to the stabilized cat qubits, the stabilized SC qubits also possess a biased noise channel (with one type of error dominant over others), with an even larger bias (defined to be the ratio between the dominant error rate and the others) ~e^{n̅2} (compared to ~e^{n̅} for the cat), where n̅ denotes the mean excitation number of the codewords. Consequently, the stabilized SC qubits can be concatenated with a DV code tailored towards the biased noise to realize low-overhead fault tolerant QEC and quantum computation. A set of operations is developed for the SC that are compatible with the engineered dissipation and can preserve the noise bias needed for the concatenation. Compared to those for the cat, these operations suffer less from the loss errors because of the AutoQEC. Moreover, they can be implemented faster due to a larger effective dissipation gap and a cancellation of the leading-order non-adiabatic errors. In combination, the access to higher-quality operations leads to much better logical performance in the concatenated level using the SC qubits. For instance, one-to-two orders of magnitude improvement can be achieved in the κ₁/κ₂ threshold, where κ₁ is the excitation loss rate and κ₂ is the engineered dissipation rate, for the surface-SC and repetition-SC scheme (compared to surface-cat and repetition-cat, respectively). Furthermore, the repetition-SC can achieve a logical error rate as low as 10⁻¹⁵, which already suffices for many useful quantum algorithms, even using a small SC with n̅=4 under a practical noise ratio κ₁/κ₂=10⁻³.

Various aspects of the SC encoding were studied with an emphasis on the enhanced protection against dephasing provided by squeezing. Some other implementations neither explored the enhanced noise bias provided by squeezing, nor exploited the ability to concatenate the SC code with outer DV codes using bias-preserving operations. various implementations may provide an explicit, fully autonomous approach to SC QEC that exploits low-order nonlinearities, and it is compatible with several experimental platforms. In contrast, some other implementations studied an approach requiring explicit syndrome measurements and a formal, numerically-optimized recovery operation. It was unclear how such an operation could be feasibly implemented in experiment. The SC may be used in the context of quantum transduction.

### Results of Exemplary Embodiments

### Squeezed Cat Encoding

The codewords of the SC are defined by applying a squeezing along the displacement axis (which is taken to be real) to the cat codewords:

$$\vert {SC}_{r , {α}^{′}}^{\pm } 〉 := \hat{S} ( r ) \vert {C}_{{α}^{′}}^{\pm } 〉 \qquad ( 1 )$$

where

$$\vert {C}_{{α}^{′}}^{\pm } 〉 := {𝒩}_{\pm } ( \vert {α}^{′} 〉 + \vert - {α}^{′} 〉 )$$

with

$${𝒩}_{\pm } = \frac{1}{\sqrt{2 ( 1 \pm {e}^{- 2 {α}^{′2}} )}}$$

being normalization factors, and

$$\hat{S} ( r ) := exp [ \frac{1}{2} r ( {\hat{a}}^{2} - {\hat{a}}^{†2} ) ]$$

is the squeezing operator. The above codewords with even

$$( \vert {SC}_{r , {α}^{′}}^{+} 〉 )$$

and odd

$$( \vert {SC}_{r , {α}^{′}}^{-} 〉 )$$

excitation number parity are defined to be the X-basis eigenstates. Similar to other bosonic codes, the performance of the SC code is related to the mean excitation number n̅ of the codewords:

$$\begin{matrix}\overline{n} := \frac{1}{2} ( 〈 {SC}_{r , {α}^{′}}^{+} \vert {\hat{a}}^{†} \hat{a} \vert {SC}_{r , {α}^{′}}^{+} 〉 + 〈 {SC}_{r , {α}^{′}}^{-} \vert {\hat{a}}^{†} \hat{a} \vert {SC}_{r , {α}^{′}}^{-} 〉 ) \\ = {α}^{′2} ( coth 2 {α}^{′2} cosh 2 r - sinh 2 r ) + {sinh}^{2} r\end{matrix} \qquad ( 2 )$$

For a SC code with fixed n̅, according to Eq. (2), the amplitude α′ of the underlying coherent states varies with the squeezing parameter r as

$${α}^{′} \approx \sqrt{\overline{n} - {sinh}^{2} r} {e}^{r} , \qquad ( 3 )$$

which holds for the regime of interest where α′>1. A graphic illustration of the interdependency between n̅, α′ and r may be presented. α′ is closely related to how separated in phase space the two computational-basis states are, which determines their resilience against local error processes. At fixed n̅, α′² can be written as a concave quadratic function of e^{2r}, which has a maximum

$${α}_{max}^{′2} = {\overline{n}}^{2} + \overline{n} .$$

For the SC, it is convenient to consider the subsystem decomposition of the oscillator Hilbert space [symbol] = [symbol] _{L}⊗ [symbol] _{g}, where [symbol] _{L} represents a logical sector of dimension 2 (referred as a logical qubit) and [symbol] _{g} represents a gauge sector of infinite dimension (referred as a gauge mode). Analogous to the modular subsystem decomposition of the GKP qubit, whose logical sector carries the modular value of the quadratures, the logical sector of the SC carries the parity information (excitation number modulo 2). Similar decomposition for the cat was used. A basis may be chosen under the subsystem decomposition spanned by squeezed displaced Fock states |± [symbol] _{L}⊗|\tilde{\hat{n}}=n [symbol] _{g}≈ [symbol] _{±,n}Ŝ(r)[\hat{D}(α′)±(−1)ⁿ\hat{D}(−α′)]|n [symbol] (≈is used since the right-hand side should be orthonormalized within each parity branch). By choosing this basis, the SC codewords in Eq. (1) coincide with |± [symbol] _{L}⊗|\tilde{\hat{n}}=0 [symbol] _{g}, i.e., the codespace is the two-dimensional subspace obtained by projecting the gauge mode to the ground state. Furthermore, the bosonic annihilation operator â can be expressed as

$$\hat{a} = {\hat{Z}}_{L} ⊗ ( {e}^{- r} {α}^{′} + cosh r \hat{\tilde{a}} - sinh r {\hat{\tilde{a}}}^{†} ) + 𝒪 ( {e}^{- 2 {α}^{′2}} ) , \qquad ( 4 )$$

where \hat{Z}_{L} is the Pauli Z operator acting on the logical qubit, and

$${\hat{\tilde{a}} = {\sum }_{n = 0}^{∞} \sqrt{n + 1} \vert \hat{\tilde{n}} = n 〉}_{g} 〈 \hat{\tilde{n}} = n + 1 \vert$$

is the annihilation operator acting on the gauge mode.

Typical bosonic systems suffer from excitation loss (â), heating (â^{†}), and dephasing (â^{†}â) errors, with loss being the prominent one. The SC code can correct the loss errors by analyzing the Knill-Laflamme error correction conditions and evaluating the QEC matrices. Consider a pure loss channel with a loss probability γ, the leading-order Kraus operators are {Î, \sqrt{γ}â}. The detectability of a single excitation loss is quantified by the matrix:

$$\begin{matrix}{\hat{P}}_{code} \hat{a} {\hat{P}}_{code} = {e}^{- r} {α}^{′} \frac{q + {q}^{- 1}}{2} {\hat{Z}}_{c} + {ie}^{r} {α}^{′} \frac{q - {q}^{- 1}}{2} {\hat{Y}}_{c} \\ \approx \sqrt{\overline{n} - {sinh}^{2} r} {\hat{Z}}_{c} - {ie}^{r} {α}^{′} {e}^{- 2 {α}^{′2}} {\hat{Y}}_{c}\end{matrix} , \qquad ( 5 )$$

where \hat{P}_{code} is the projection onto the code space, \hat{Z}_{c}:=\hat{Z}_{L}⊗|0 [symbol] _{g} [symbol] 0|(Ŷ_{c}:=Ŷ_{L}⊗|0 [symbol] _{g} [symbol] 0|) is the Pauli Z (Y) operator in the code space, and

$$q := \sqrt{\frac{1 - {e}^{- 2 {α}^{′2}}}{1 + {e}^{- 2 {α}^{′2}}}} .$$

The approximation in the second line is made in the regime of interest where e^{-2α′}^{²}«1.

Eq. (5) indicates that a single excitation loss mostly leads to an undetectable logical phase-flip error with a probability that decrease with the squeezing parameter r, which can be better understood by considering the action of the decomposed â operator (Eq. (4) on the codeword â(|+ [symbol] _{L}⊗|0 [symbol] _{g})=|− [symbol] _{L}⊗\sqrt{n̅}(\sqrt{η}|0 [symbol] _{g}−\sqrt{1−η}|1 [symbol] _{g}), where

$$η := ( \overline{n} - {sinh}^{2} r ) / \overline{n} . \qquad ( 6 )$$

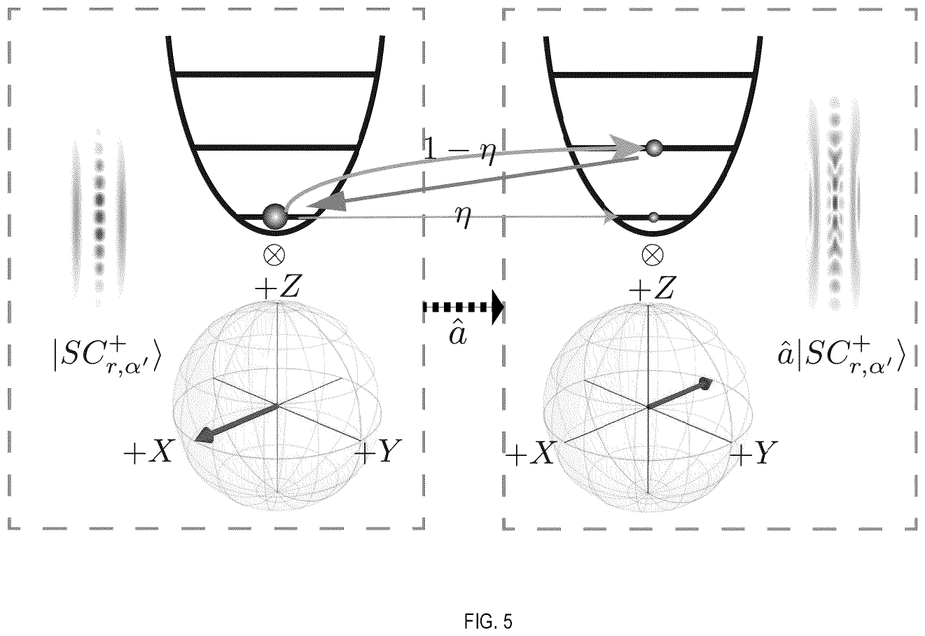

As shown in FIG. 5, after a single excitation loss, the branch of the population (with ratio n) that stays in the ground state of the gauge mode leads to undetectable logical phase-flip errors. In contrast, the other branch (with ratio 1−η) that goes to the first excited gauge state is in principle detectable. The detectable branch is also approximately correctable since \hat{P}_{code}â^{†}â\hat{P}_{code}≈n̅Î_{c}+ [symbol] (e^{-2α′}^{²})\hat{X}_{c}. Therefore, it is expected to suppress the loss-induced phase flip errors by a factor η that decreases with the squeezing r. Moreover, the \hat{X}_{c} and Ŷ_{c} terms in the QEC matrices for both loss, heating, and dephasing are exponentially suppressed by α′². As shown in Eq. (3), α′² can be greatly increased by adding squeezing

$$( with {α}_{max}^{′2} = {\overline{n}}^{2} + \overline{n} ) .$$

Consequently, it is expected that the SC can also have significantly enhanced noise bias compared to the cat.

### Autonomous Quantum Error Correction

The SC encoding can, in principle, detect and correct the loss errors. An explicit and practical recovery channel is described. This section describes such a recovery channel, showing surprisingly that it requires only experimental resources that have been previously demonstrated.

As shown by the blue arrow in FIG. 5, in principle, photon counting measurement may be performed on a probe field that is weakly coupled to the gauge mode, and a feedback parity flip \hat{Z}_{L} may be applied on the logical qubit upon detecting an excitation in the probe field. Such measurement and feedback process can be equivalently implemented by applying the dissipative dynamics as described by Lindblad master equation

$$\frac{d \hat{ρ}}{dt} = {κ}_{2} 𝒟 [ \hat{F} ] ,$$

with the jump operator \hat{F} given by

$$\hat{F} = ( {\hat{Z}}_{L} ⊗ \hat{\tilde{I}} ) \hat{S} ( r ) ( {\hat{a}}^{2} - {α}^{′2} ) {\hat{S}}^{†} ( r ) , \qquad ( 7 )$$

and

$$𝒟 [ \hat{A} ] \hat{ρ} := \hat{A} \hat{ρ} {\hat{A}}^{†} - \frac{1}{2} \{ {\hat{A}}^{†} \hat{A} , \hat{ρ} \} .$$

When α′»1, \hat{F}∝\hat{Z}_{L}⊗\tilde{â} represents a logical phase flip conditioned on the gauge mode losing an excitation. In the Fock basis, such an operator can be approximately given by

$$\hat{F} \approx \frac{1}{{α}^{′}} \hat{S} ( r ) ( {c}_{1} \hat{a} + {c}_{2} {\hat{a}}^{†} ) ( {\hat{a}}^{2} - {α}^{′2} ) {\hat{S}}^{†} ( r ) , \qquad ( 8 )$$

with c₁+c₂=1.

In other paragraphs in the present disclosure, two reservoir-engineering approaches may be described to implement such a nontrivial dissipator using currently accessible experimental resources. The main ideas may be described here. The first approach utilizes three bosonic modes that are nonlinearly coupled. As shown in FIG. 9(a), a high-quality mode b and a lossy mode c, together, serve as a nonreciprocal bath that provides a directional interaction e^{-iθ\hat{Z}}^{_{L}}⊗\tilde{â} from the gauge mode to the logical qubit in the storage mode a. Such a coupled system can be physically realized in, e.g., superconducting circuits. The second approach couples a bosonic mode nonlinearly to a qutrit {|g [symbol] , |e [symbol] , |f [symbol] }. As shown in FIG. 10, the bosonic mode is coupled to the gf transition via Ŝ(r)(â²−a′²)Ŝ^{†}(r)|f [symbol] [symbol] g|+h.c. and to the ef transition via \hat{Z}_{L}|e [symbol] [symbol] f|+h.c. By enhancing the decay from |e [symbol] to |g [symbol] , the effective dissipator \hat{F} may be obtained by adiabatically eliminating both |e [symbol] and |f [symbol] . Such a system can be physically realized in, e.g., trapped-ion system.

With the engineered dissipator in Eq. (7), the SC can be autonomously protected from excitation loss, heating and dephasing. The error channel of the dissipatively stabilized SC qubit in the memory level may be derived. The dynamics of the system are described by the Lindblad master equation:

$$\frac{d \hat{ρ}}{dt} = {κ}_{2} 𝒟 [ \hat{F} ] \hat{ρ} + {κ}_{1} ( 1 + {n}_{th} ) 𝒟 [ \hat{a} ] \hat{ρ} + {κ}_{1} {n}_{th} 𝒟 [ {\hat{a}}^{†} ] \hat{ρ} + {κ}_{ϕ} 𝒟 [ {\hat{a}}^{†} \hat{a} ] \hat{ρ} . \qquad ( 9 )$$

The logical phase-flip and bit-flip error rates of the SC under the dynamics described by Eq. (9) can be analytically obtained (see other paragraphs in the present disclosure for the derivations):

$${γ}_{Z} = [ {κ}_{1} ( 1 + 2 {n}_{th} ) + {κ}_{ϕ} {e}^{- 2 r} ] ( \overline{n} - {sinh}^{2} r ) , \qquad ( 10 )$$

$${γ}_{X , Y} = {κ}_{ϕ} \frac{( \overline{n} - {sinh}^{2} r ) {e}^{2 r} ( {sinh}^{2} 2 r / 4 + cosh 4 r )}{2 sinh ( 2 ( \overline{n} - {sinh}^{2} r ) {e}^{2 r} )} , \qquad ( 11 )$$

where γ_{X,Y} denotes the sum of the logical X and Y error rates, referred as the bit-flip rate for simplicity, the full error channel of the stabilized SC, is not a Pauli error channel in general. For simplicity, the Pauli-twirling approximation is taken, only keeping the diagonal terms of the process matrix in the Pauli basis. Only the dephasing error κ_{φ} [symbol] â^{†}â] may be considered for γ_{X,Y} since the loss-induced bit-flip rate has a more favorable scaling ~e^{-4α′}^{²} with α′. The loss and the heating contribute to γ_{Z} in the same way (both suppressed by a factor η) since their undetectable portion (η) is the same (see Eq. (4) and its hermitian conjugate). The dephasing also contributes to γ_{Z}, but with an extra e^{-2r} suppression, when combined with the parity-flipping dissipator \hat{F}. Setting r=0 and removing the κ_{φ} term in γ_{Z}, the error rates of the dissipative cat may be restored.

In the regime where e^{-r}«1 and γ_{Z} is mainly contributed by excitation loss, Eqs. (10) and (11) may be simplified as

$${γ}_{Z} \approx η \overline{n} {κ}_{1} , {γ}_{X , Y} \approx \frac{9}{16} {κ}_{ϕ} {α}^{′2} {e}^{- 2 {α}^{′2}} {e}^{4 r} , \qquad ( 12 )$$

$$where$$

$${α}^{′} \approx \sqrt{4 η ( 1 - η )} \overline{n} . \qquad ( 13 )$$

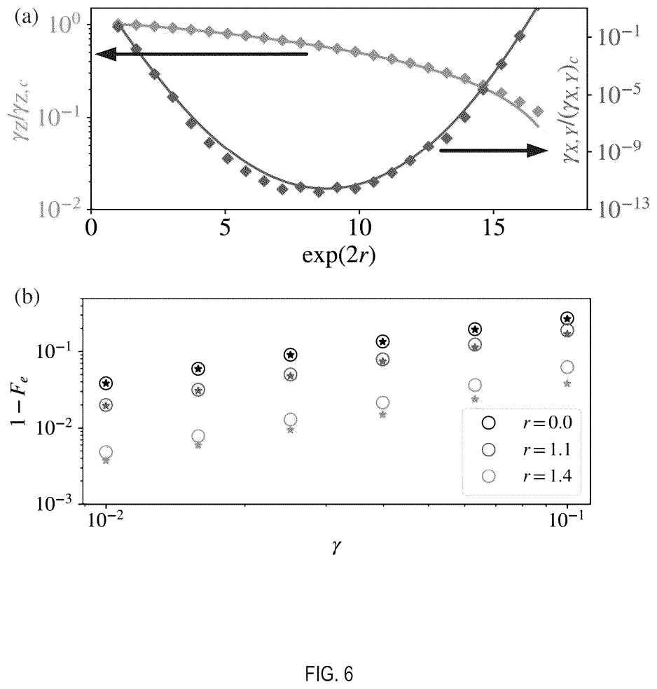

As plotted in FIG. 6(a), fixing n̅, γ_{Z} decreases monotonically with the squeezing r (unless r approaches the maximum squeezing rₘₐₓ≈sin h⁻¹(\sqrt{n̅}).) as the undetectable portion η of the loss-induced errors decreases (see Eq. (6)). The change of γ_{X,Y} with r (or equivalently, η) is roughly captured by the change in the displacement amplitude α′ (see Eq. (13)), and γ_{X,Y} takes the minima roughly when α′ reaches the maxima

$${α}_{max}^{′} = \sqrt{{\overline{n}}^{2} + \overline{n}} .$$

Note that the minimal bit-flip rate of the SC enjoys a more favorable scaling γ_{X,Y}∝e^{-2n̅}^{²} with n̅, compared to γ_{X,Y}∝e^{-2n̅} for the cat, so that the SC can have a much larger noise bias under the same excitation number constraint.

In principle, one needs to consider the tradeoff between γ_{Z} and α′ and choose the optimal η depending on the tasks of interest. Smaller η leads to better protection from excitation losses, which is preferred by, e.g., the idling operations. Larger α′, on the other hand, leads to a larger noise bias and a widened effective dissipation gap (≈2κ₂α′²), which can support faster operations, e.g., the bias-preserving CX gate introduce in the next section. The effective dissipation gap is defined as the the excitation gap of the effective Hamiltonian

$${\hat{H}}_{eff} = \frac{1}{2} {κ}_{2} {\hat{F}}^{†} \hat{F} = \frac{1}{2} {κ}_{2} {\hat{S}}^{( r )} ( {\hat{a}}^{†2} - {α}^{′2} ) ( {\hat{a}}^{2} - {α}^{′2} ) {\hat{S}}^{†} ( r ) ,$$

which characterizes the leakage rate and the non-adiabatic error rate under a Hamiltonian perturbation. Since Ĥ_{eff} is the same as that for a cat with a displacement α′ up to a unitary transformation, the effective dissipation gap for the dissipative SC is 2κ₂α′². In the following, it is fixed that n̅=4 and η=¼ if not specified otherwise, which corresponds to a squeezing of r=1.32 (11.5 dB). Such a parameter choice leads to γ_{Z}≈κ₁, which removes the enhancement factor n present for the stabilized cats (for n̅=4). Meanwhile,

$${α}^{′2} \approx \frac{3}{4} {\overline{n}}^{2}$$

provides a sufficiently large noise bias and a large effective dissipation gap.

In FIG. 6(b), the performance of the Auto-QEC scheme is benchmarked against loss errors by comparing it to the optimal recovery channel given by a semidefinite programming (SDP) method. The composite channel [symbol] = [symbol] · [symbol] . ε is considered, where ε denotes the encoding map from a qubit to the SC, [symbol] denotes a Gaussian pure loss channel (corresponding to Eq. (9) with κ₂=κ_{φ}=nₜₕ=0) with loss probability γ:=κ₁t, and [symbol] denotes the recovery channel either using the autonomous QEC with the dissipator Eq. (7) or the optimal recovery channel. The entanglement fidelity Fₑ:=<Φ⁺|( [symbol] ⊗ [symbol] )|Φ⁺ [symbol] [symbol] Φ⁺|)|Φ⁺ [symbol] is used, where |Φ⁺ [symbol] denotes a Bell state for the logical qubit and an ancilla qubit, as the error metric for the composite channel. The entanglement infidelity (EI) 1−Fₑ is evaluated as a function of the loss probability γ. The EI is the objective function for the SDP. As shown in FIG. 6(b), the EI obtained using the Auto-QEC is close to the optimal EI, especially in the low-γ regime, demonstrating that the autonomous QEC scheme is close to optimal for correcting excitation loss errors. It may be crucial to have the phase-flip \hat{Z}_{L} correction in the dissipator \hat{F} in order to correct the loss-induced phase-flip errors. Otherwise, a simple dissipator Ŝ(r)(â²−α′²)Ŝ^{†}(r) directly generalized from the dissipative cat would still give an unsuppressed phase-flip rate γ_{Z}=κ₁n̅.

The SC encoding also emerges as the optimal or close-to-optimal singlemode bosonic code through a bi-convex optimization (alternating SDP) procedure for a loss and dephasing channel with dephasing being dominant.

### Bias-Preserving Operations

To apply the autonomously protected SC for computational tasks, developing a set of gate operations that are compatible with the engineered dissipation may be needed. Furthermore, the operations should preserve the biased noise channel of the SC, which can be utilized for resource-efficient concatenated QEC and fault-tolerant quantum computing. A set of bias-preserving operations [symbol] ={ [symbol] _{X}, X, Z(θ), ZZ(θ), CNOT, Toffoli} may be developed for the SC, which suffice for many concatenated QEC schemes (e.g. concatenation with the repetition codes or the surface codes). The detailed design of each operation is described in other paragraphs in the present disclosure.

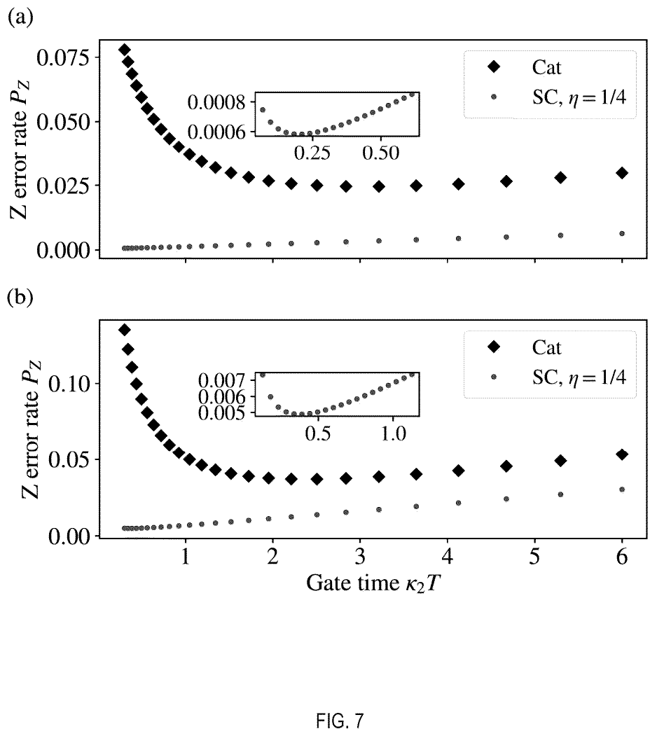

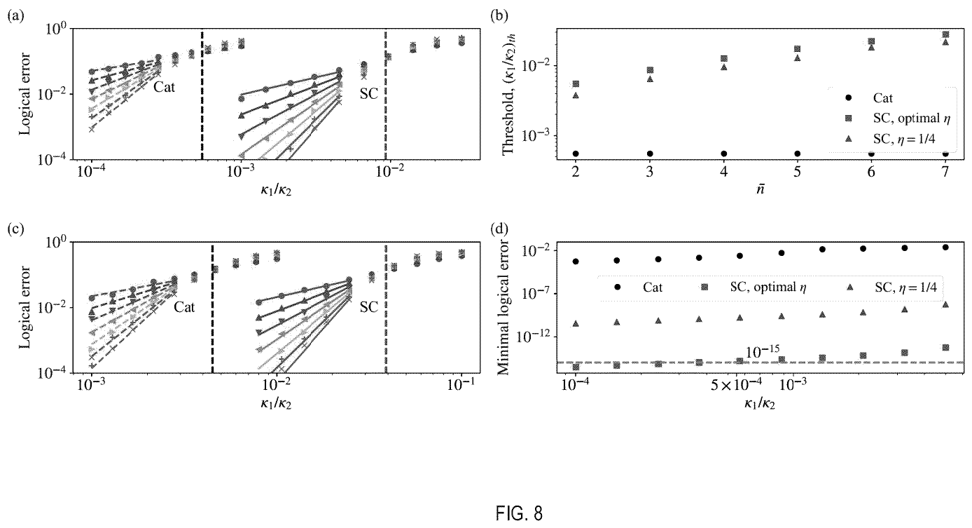

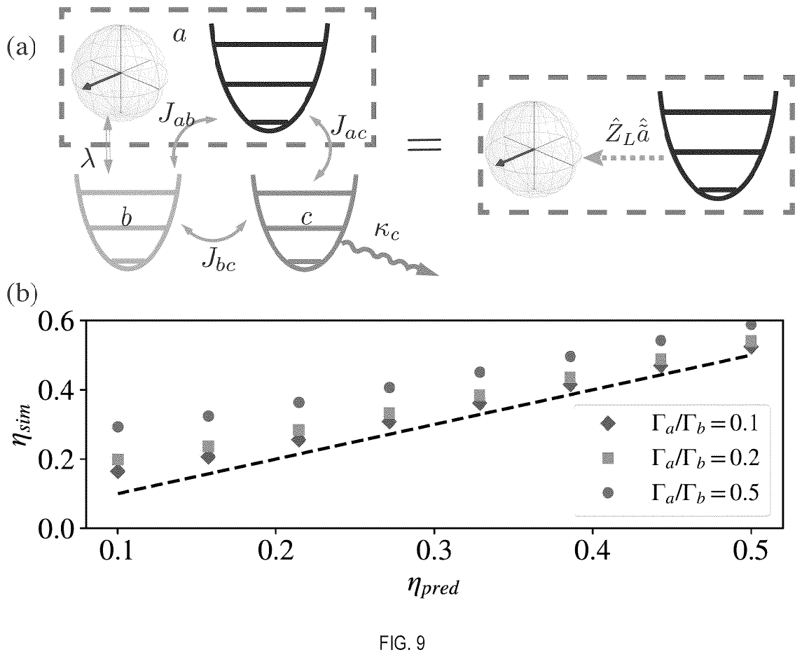

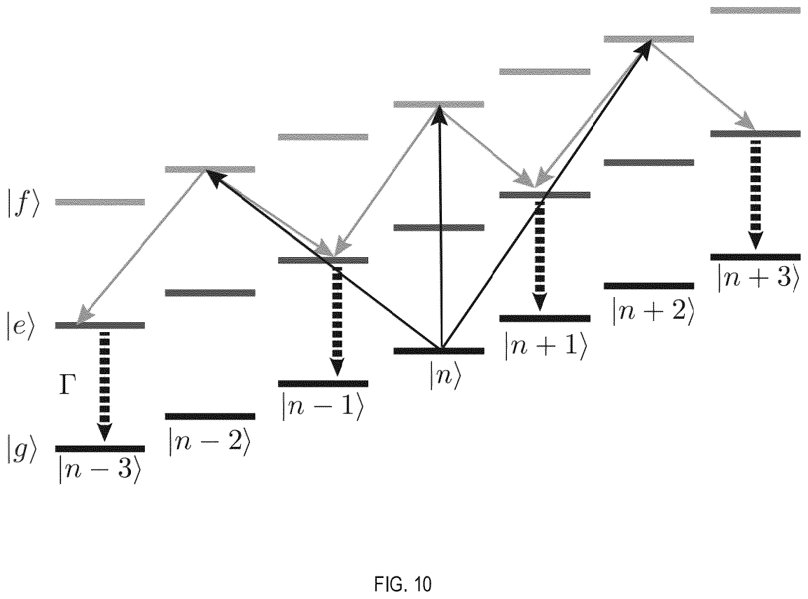

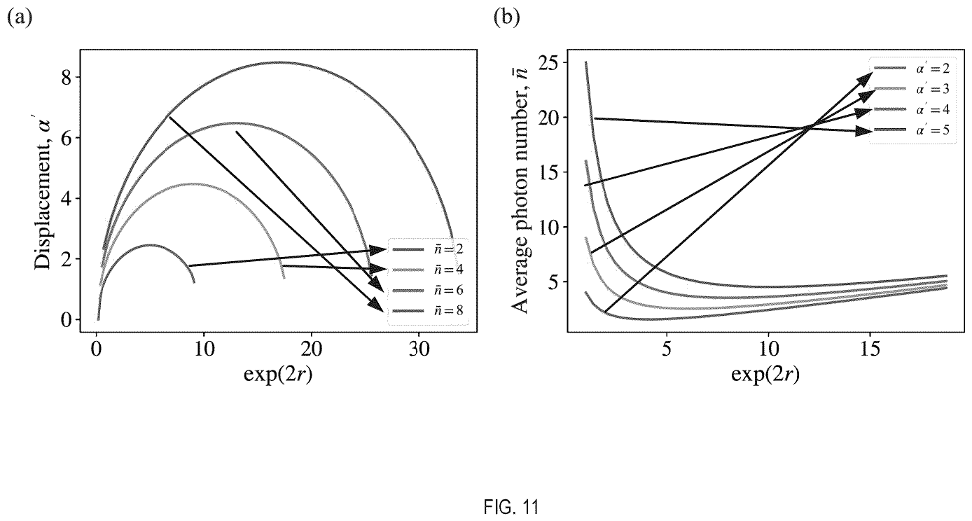

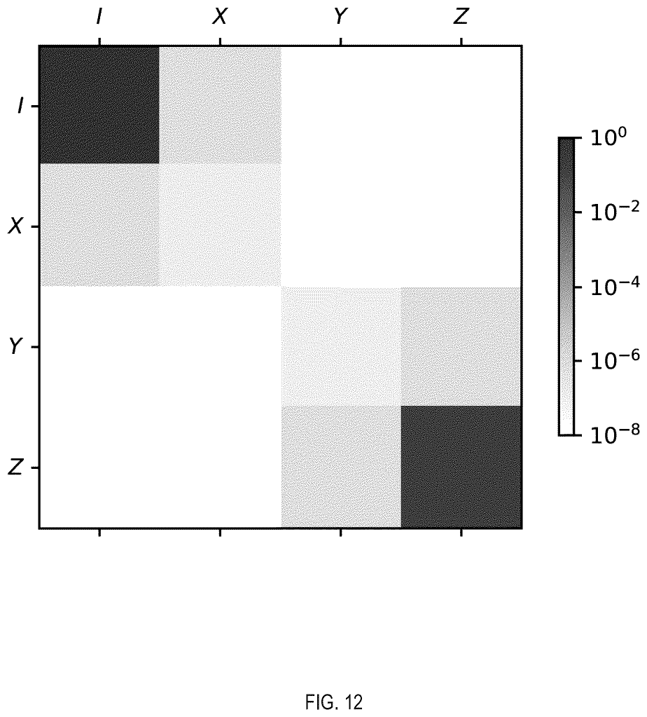

Overall, the bias-preserving operations for the SC can achieve much higher fidelity (lower dominant Z-type error rates) than those for the cat for the following two reasons: (1). The operations suffer less from the excitation loss errors, which are (partially) autonomously corrected. (2). The non-adiabatic errors are significantly suppressed by the \hat{Z}_{L} correction in the dissipator \hat{F} (see Eq. (7)) and the enlarged effective dissipation gap (∝α′²), so that the gate operations could be implemented faster. FIG. 7 shows the total Z-type error rates for the Z-axis rotation Z(θ) and the CX gate as a function of the gate time. Compared to some other cat gates with the same ñ, the SC Z(θ) (CX) gate can achieve a 42.0 (7.56) times reduction in the lowest error rates. While η=¼ is fixed, it is not necessarily the optimal choice of the squeezing. In fact, with η approaching ½, even lower errors may be obtained at faster gate times.

Compared to the cat stabilized by \hat{α}²−α², a simple extension to a SC stabilized by Ŝ(r)(â²−α′²)Ŝ^{†}(r) can also lead to improvement in the gate speed and fidelities due to the enlarged effective dissipation gaps. However, adding the extra phase flip in the dissipator brings a much more significant improvement due to the suppression of the loss-induced errors and the leading-order non-adiabatic errors.

### Concatenated Quantum Error Correction

With the bias-preserving operations, the SC may be concatenated with an outer discrete-variable code to suppress the logical error rates to the desired level. To compare the SC with the standard cat, the concatenation with a repetition code and a thin rotated surface code may be considered. The surface-cat scheme can arbitrarily suppress the errors in a resource-efficient manner once the ratio between the loss rate κ₁ and the engineered dissipation rate κ₂ is below a certain threshold. The repetition-cat, on the other hand, cannot arbitrarily suppress the errors for a cat with constrained n. Below a κ₁/κ₂ threshold, as the repetition code size increases, the logical Z error rate is exponentially suppressed while the logical X error is linearly amplified. Thus, a minimal total logical error rate is present.

The concatenated schemes with the cat face several challenges. First, the κ₁/κ₂ thresholds (e.g., ~5×10⁻⁴ for the surface-cat in FIG. 8(a).) are very low because of the low-fidelity bias-preserving operations. Also, the minimal logical error probability of the repetition-cat (e.g., ~10⁻² for n̅=4, see FIG. 8(d)) is not low enough for fault-tolerant algorithms, except for cats with very large mean photon number, because of the limited noise bias.

The following few paragraphs of the present disclosure describe that these challenges can be overcome by using the dissipative SC. The κ₁/κ₂ thresholds for both the surface code and the repetition code can be significantly improved by concatenating with the dissipative SC. Moreover, the repetition-SC can reach sufficiently low logical error probability ~10⁻¹⁵ even with a small SC n̅=4 (see FIG. 8(d)). It is worth noticing that the thresholds for concatenated cat code shown in FIG. 8 (a, c) are approximately independent of the size the cat since the optimal CNOT gate error is independent of n for cat code.

Firstly, the concatenation of the SC with a d_{X} by d_{Z} thin surface code may be considered. The X distance d_{X} may be fixed to 3, which suffices to suppress the logical X error rate, and increase the Z distance d_{Z} to suppress the logical Z error rate. At fixed η=¼, the logical Z error probability is obtained for d_{Z} code cycles as a function of κ₁/κ₂ for different d_{Z}, as shown in FIG. 8(a). The physical error rates of each physical operation involved in the surface-code QEC are described in other paragraphs of the present disclosure. A κ₁/κ₂ threshold is obtained at 0.93%, which is around 20 times higher than that of the surface-cat. By optimizing the choice of the squeezing, the maximum threshold obtained for n̅=4 is around 1.2%. Moreover, FIG. 8(b) shows that this threshold can be further increased to about 3% by increasing n̅ to 7. Note that the κ₁/κ₂ threshold of the surface-cat remains almost the same when increasing n̅. The increase of the κ₁/κ₂ threshold (for the concatenated SC schemes) may be attributed to the reduced physical-operation error rates.

Next, the concatenation of the SC with a repetition code with size d_{Z} is considered. As shown in FIG. 8(c), a 3.9% κ₁/κ₂ threshold is obtained for the logical Z error rate, which is roughly 9 times higher than that of the repetition-cat. Below the κ₁/κ₂ threshold, as previously mentioned, a minimal total logical error rate is present. To obtain the minimal total logical error rate (by optimizing over d_{Z}), approximate expressions is obtained for the logical Z and X error probabilities in the sub-threshold regime (κ₁/κ₂<10⁻³):

$${p}_{L}^{Z} \approx 0.059 {{d}_{Z} ( \frac{{p}_{Z}^{′}}{0.056} )}^{0.48 {d}_{Z}} , \qquad ( 14 )$$

$${p}_{L}^{X} \approx 2 {d}_{Z} ( {d}_{Z} - 1 ) {p}_{X , Y} ,$$

where p′_{Z}:=p_{Z}_{ₜ}+p_{Z}_{_{c}}_{Z}_{ₜ} denotes the sum of the target-mode and the correlated phase-flip rate of the CX gate (phase flips on the control mode have negligible contribution to the logical error rate for the repetition code), p_{X,Y} the total non-Z error rates of the CX gate (the total rates of all the two-qubit Pauli errors that do not contain Z terms). p′_{Z} and p_{X,Y} are in general functions of the CX gate time κ₂T. To obtain simple expressions for them, the CX gate time is restricted to be κ₂T≥1, which limits the nonadiabatic leakage during the gate. In this regime,

$${p}_{Z}^{′} \approx {κ}_{1} \overline{n} T , {p}_{X , Y} \approx 5.57 \times \frac{{e}^{- 2 {α}^{′2}}}{{α}^{′2}} \frac{1}{{κ}_{2} T} .$$

No contribution from the loss rate κ₁ to p_{X,Y} is observed since for fast gate, p_{X,Y} is dominated by the nonadiabatic errors.

$${p}_{L} = {p}_{L}^{Z} + {p}_{L}^{X}$$

FIG. 8(d) shows the minimal total logical error probability of the repetition-SC by optimizing d_{Z} and κ₂T for n̅=4 and η=¼. As a comparison, minimal logical error probabilities of the repetition-cat with n̅=4 using the physical error rates may be included. When κ₁/κ₂>10⁻³, the optimal gate error is no longer attained under the long gate time constraint, κ₂T≥1 for the SC. Therefore, in that regime, the SC results can be understood as an upper bound of the minimum total logical error rates. For a practical noise ratio κ₁/κ₂=10⁻³, the minimal logical error probability of the repetition-SC can reach ~10⁻¹⁵, which suffices for many useful quantum computational tasks. In contrast, the logical error probability of the repetition-cat (with n̅=4) can only reach ~10⁻², which is far from being useful. Even with a larger cat size of n̅=8, the minimum logical error probability is still roughly ~10⁻⁵ at such a noise ratio. To reach a similar level of logical error probability as the repetition-SC, either a much larger cat with n̅»10 (with the repetition code), or a more sophisticated outer code, e.g., the surface code, may be needed. The drastic reduction in the minimal logical error rate of the repetition-SC may be attributed to the significantly enhanced noise bias, or equivalently, the reduced physical bit-flip rates of the SC, which are exponentially suppressed by n̅², instead of n̅ for the cat.

Additional Comparisons with the Cat

The present disclosure benchmarks the performance of the concatenated codes as a function of κ₁/κ₂ for both the cat and the SC, and it might be of different difficulty level to engineer the same dissipation rate κ₂ for the cat and the SC, depending on the hardware implementation. Therefore, the performance of the concatenated codes may be compared as a function of κ₁/M, where M is the physical rate that is most challenging to engineer in practice. For non-limiting examples, the implementation may be focused on superconducting circuits.

For example, a potential hardware challenge is to engineer strong nonlinear couplings. In this case, the concatenated codes may be compared as a function of κ₁/Jₘ, where Jₘ denotes the largest nonlinear coupling strength required. For the cat, Jₘ is simply given by g₂, the strength of the two-photon exchange Hamiltonian g₂(â²\hat{b}^{\}+h.c.). Assuming an adiabaticity constraint ϵ, the lossy mode can be adiabatically eliminated, and Jₘ=\sqrt{n̅}κ₂/2ϵ. For the SC, the maximum nonlinear coupling strength is given by Jₘ=α′ sin h 2rκ₂/\sqrt{ϵ₀}. Here, ϵ₀ is the relevant adiabatic condition for the described stabilization scheme using three bosonic modes.

Using these relations, the horizontal axis in FIG. 8(a) may be changed to κ₁/Jₘ and about a 3.5 times increase may be obtained in the κ₁/Jₘ threshold for the surface-SC compared to the surface-cat. Furthermore, results in FIG. 8(a) are obtained by optimizing the parameters, such as the squeezing r and the gate times, with the target function set to be the threshold in κ₁/κ₂. If the target function is set to the threshold in κ₁/Jₘ instead, it is likely that the optimal code parameters are different, and the corresponding threshold could be further increased. Based on these considerations, it is expected that the SC should maintain advantages over the cat even considering the experimental constraints (which will be hardware-specific) in the circuit level. Optimizing the hardware design and quantifying the hardware-specific improvement may be performed.

Comparison with the Squeezed Cat Stabilized by a Parity-Preserving Dissipator

To better understand the novelty and necessity of the partity-flipping dissipator \hat{F} in Eq. (7), it is compared with a parity-preserving dissipator

$${\hat{F}}^{′} = \hat{S} ( r ) ( {\hat{a}}^{2} - {α}^{′2} ) {\hat{S}}^{†} ( r ) \approx 2 {α}^{′} {\hat{I}}_{L} ⊗ \hat{\tilde{a}} , \qquad ( 15 )$$

which is a straightforward extension from â²-α² that stabilizes the cat. Such a dissipator was considered for stabilizing the SC. The extra phase-flip correction in \hat{F} is essential for reducing SC's error rate in both the memory level and gate operations, which then leads to better logical performance in the concatenated level.

In the memory level, the change of a parity flip on the dissipator does not affect the bit-flip error rate derived in Eq. (11). So a SC stabilized by \hat{F}′ can also have a favorable scaling between the minimal bit-flip rate and n̅: γ_{X,Y}∂e^{-2n̅}^{²}. Nevertheless, \hat{F}′ lacks the parity flip Z_{L} that corrects the detectable portion of the loss-induced errors, as shown clearly from FIG. 5 (the missing of the blue arrow). Therefore, a SC stabilized by \hat{F}′ is not capable of correcting the loss errors. As such, it suffers from the same phase-flip error rate as a cat, γ_{Z}=κ₁n̅.

Regarding the gate operations, the Z rotation and the CNOT gate may be taken as examples. For the Z rotation, a SC stabilized by \hat{F}′ only enjoys a suppression in the non-adiabatic errors by the the increased adiabatic gap, 4κ₂α′², compared to conventional cat of the same n̅. In contrast, a SC stabilized by \hat{F} corrects the leading-order non-adiabatic error in 1/α′², since the the extra \hat{Z}_{L} in \hat{F} compensates the parity-flip associated with the non-adiabatic transition (to the leading order). The residual errors are proportion to the correction factor, ξ∝1/α′², see Eq. (33). Therefore, while the minimal Z(θ) gate error for the SC with \hat{F}′ is roughly suppressed by a factor 1/n̅ compared to the cat, that for the SC with \hat{F} is suppressed by an 1/n̅² factor (see Table 1). All errors are normalized by the optimal gate errors of the cat, which are given by

$${p}_{Z ( θ )} = \frac{θ}{2} \sqrt{\frac{1}{\overline{n}} \frac{{κ}_{1}}{{κ}_{2}}} and {p}_{CNOT} = \frac{π}{2 \sqrt{2}} \sqrt{\frac{{κ}_{1}}{{κ}_{2}}} .$$

The definitions of \hat{F} and \hat{F}′ are given in Eq. (7) and Eq. (15) respectively. The optimal gate errors for SC are reached at

$$η \approx \frac{1}{2} .$$

The optima Z(θ) gate time for SC with \hat{F}′ and \hat{F} are approximately

$$\frac{π}{4 \sqrt{{κ}_{1} {κ}_{2}}} {\overline{n}}^{- 5 / 2} and \frac{π}{4 \sqrt{3 {κ}_{1} {κ}_{2}}} {\overline{n}}^{- 7 / 2}$$

respectively. The gate time for CNOT are approximately

$$\frac{π}{4 \sqrt{2 {κ}_{1} {κ}_{2}}} {\overline{n}}^{- 3 / 2} and \frac{π}{12 \sqrt{{κ}_{1} {κ}_{2}}} {\overline{n}}^{- 5 / 2}$$

respectively. Since the cooling time is mostly assumed to be constant in the gate scheme, it is neglected for simplicity. Only the scaling of the gate errors with n for the SC is provided since the exact expressions are complicated.

The errors of CNOT operation can be analyzed in a similar fashion. Due to

TABLE 1
Optimal gate error rate of the SC gates compared to the cat.

| Normalized | SC with | SC with |
|---|---|---|
| gate error | \hat{F}′ | \hat{F} |
| Z(θ) | 1/(n̅ + 1) | ~n̅⁻² |
| CNOT | 2/\sqrt{n̅ + 1} | ~n̅^{-3/2} |

the enlarged adiabatic gap, the minimal Z error rate of the SC gate with \hat{F}′ is a factor of

$$\frac{2}{\sqrt{\overline{n} + 1}}$$

smaller than that of the cat gate. For the mean excitation number, n=4, this factor is only slightly less than 1. However, with the parity-flipping dissipator \hat{F}, the gate error enjoys a n suppression in the loss errors and an additional ∝1/α′² suppression in the non-adiabatic error. Combining these advantages, the CNOT gate error ratio with that of the cat roughly scales as n̅^{-3/2} (see Table 1).

Since the fault-tolerant threshold is mostly limited by errors of the CNOT and the idling operation, the thresholds of the concatenated SC schemes using \hat{F}′ is comparable to that of the concatenated cat scheme even at optimal squeezing for small mean excitation number. As such, having the extra phase-flip correction in the dissipator \hat{F} is crucial for concatenated QEC and fault-tolerant quantum computing.

### Applications in Superconducting Circuits and Trapped-Ion Systems

The stabilized cat qubits are considered as a candidate for hardware-efficient, fault-tolerant, and scalable computation tasks in superconducting circuits. The dissipative SC, which has an overall advantage over the cat, could play an important role along this direction.

The dissipative SC could also find its application in trapped-ion systems. On the one hand, encoding into the motional states of the ions provides an alternative approach for storing and protecting the quantum information. How to process the information (e.g., implementing quantum gates) remains to be explored. On the other hand, if the information is stored in the internal states of the ions (the conventional approach), the bosonic codes like the SC could lead to more robust information processing. One could utilize multi-species ions with multiple levels and dissipatively protect the motional modes while leaving a subset of the ions' internal states that carry the information intact. The protected motional modes can, for instance, be used for scalable, parallel, and high-quality entangling gates mediated by localized phonon modes.

### Physical Realization of the Dissipator

The following paragraph describes the details of the two approaches implementing the dissipator in Eq. (7). Before describing the recipes, it is worth discussing the challenges involved here. The most straightforward method to realizing a generic Lindblad dissipator [symbol] [\hat{F}] is to couple the system to an auxiliary reservoir mode c (with decay rate κ_{c}) via a coupling Hamiltonian g(\hat{F}ĉ^{†}+h.c.). In the limit where mode c acts as a Markovian environment for the system, i.e. κ_{c}»g, it is realized that the target dissipator \hat{F} with an effective dissipation rate 4g²/κ_{c}. For the dissipator in Eq. (7), this simple route requires a strong fourth-order nonlinear coupling, which has not been demonstrated yet due to the experimental challenges.

Two approaches for realizing the desired nonlinear dissipator may be described using accessible experimental resources: The first approach utilizes three nonlinearly-coupled bosonic modes, which can be physically realized in, e.g., superconducting circuits; The second approach couples a bosonic mode nonlinearly to a qutrit, which can be physically realized in, e.g., trapped-ion system.

The first approach only requires third-order nonlinearities to implement the desired dissipator, making use of a more structured engineered dissipation. Under the subsystem decomposition of the storage mode a encoding the SC, one can realize a general nonlinear dissipator of the form [symbol] [e^{-iθZ}^{_{L}}⊗\tilde{Â}] (with an angle θ), by coupling a gauge-mode operator \tilde{Â} and an auxiliary mode b to the input and output ports of a directional waveguide, respectively, and introducing a dispersive interaction between an auxiliary mode b and the logical qubit:

$${\hat{H}}_{disp .} = \frac{λ}{2} {\hat{Z}}_{L} {\hat{b}}^{†} \hat{b} .$$

For the dissipator in Eq. (7), \tilde{Â}=\tilde{â} is chosen. The physical interactions (in the Fock basis) can be obtained from the mapping

$$\hat{\tilde{a}} \to \frac{1}{2 {α}^{′}} \hat{S} ( r ) ( {\hat{a}}^{2} - {α}^{′2} ) {\hat{S}}^{†} ( r ) , and {\hat{Z}}_{L} \to \frac{1}{2 {α}^{′}} \hat{S} ( r ) ( \hat{a} + {\hat{a}}^{†} ) {\hat{S}}^{†} ( r ) ,$$

which means that a nonlinear coupling between the storage mode a and the waveguide port is needed. While it is challenging to directly achieve this using e.g. a physical circulator, the directional dynamics can be synthetically engineered by adding another reservoir mode c. The whole setup is illustrated in FIG. 9(a), whose dynamics is given by master equation

$$\frac{d}{dt} \hat{ρ} = - i [ {\hat{H}}_{disp .} + {\hat{H}}_{tun .} , \hat{ρ} ] + {κ}_{c} 𝒟 [ \hat{c} ] , \qquad ( 16 )$$

where the tunnel coupling Hamiltonian Ĥₜᵤₙ. of the total system-reservoir is given by

$${\hat{H}}_{tun .} = {J}_{ab} {\hat{\tilde{a}}}^{†} \hat{b} + ( {J}_{ac} \hat{\tilde{a}} - {iJ}_{bc} \hat{b} ) {\hat{c}}^{†} + h . c . , \qquad ( 17 )$$

$${J}_{ab} = \sqrt{{Γ}_{a} {Γ}_{b}} / 2 , {J}_{ac} = \sqrt{{Γ}_{a} {κ}_{c}} / 2 , {J}_{bc} = \sqrt{{Γ}_{b} {κ}_{c}} / 2. \qquad ( 18 )$$

In the regime where the joint b, c modes act as a Markovian reservoir for mode a, i.e. κ_{c}»\sqrt{ΓₐΓ_{b}} and Γ_{b}»Γₐ, both b and c may be adiabatically eliminated to obtain an effective dissipator (using the effective operator formalism), as

$$\frac{d}{dt} \hat{ρ} = {Γ}_{a} 𝒟 [ \frac{i λ {\hat{Z}}_{L} - {Γ}_{b}}{i λ {\hat{Z}}_{L} + {Γ}_{b}} \hat{\tilde{a}} ] \hat{ρ} . \qquad ( 19 )$$

Setting λ=Γ_{b}, the desired dissipator \hat{Z}_{L}⊗\tilde{â} to stabilize the SC may be obtained.

When deriving Eq. (19), the physical setup Eq. (16) is required to operate in the regime where adiabatic elimination remains valid. It is thus natural to ask what are the imperfections given realistic physical parameters, i.e. when the decay rates κ_{c}, Ty of auxiliary modes b, c cannot be infinitely large. In that case, one can show the dominating error due to finite reservoir bandwidth is due to the finite decay rates κ_{c} and Γ_{b}, and it is preferable to set κ_{c}~Γ_{b} to optimize over hardware resources. In this regime, the extra error introduced by physical implementation is determined by the ratio Γₐ/Γ_{b}, which heuristically describes the branching ratio between the logical qubit population that does not undergo the parity flip (uncorrected error) and the population that does (corrected error) whenever a gauge mode excitation decays into the environment. More specifically, the discrepancy between the desired suppression factor for the loss-induced phase flip rate η_{pred} (using Eq. (6)) and the numerically extracted (achievable) value ηₛᵢₘ, as ηₛᵢₘ−η_{pred}=(1−η_{pred}) (Γₐ/2Γ_{b}). As shown in FIG. 9(b), by setting Γₐ/Γ_{b}=0.1, the desired n within 50% accuracy may be realized.

To make the required nonlinearity more clear, the physical Hamiltonian Eq. (16) in the Fock basis:

$${\hat{H}}_{tun .} = \frac{J}{2 {α}^{′}} {\hat{a}}_{s}^{†2} ( \hat{b} + \hat{c} ) - \frac{J}{2} {α}^{′} ( \hat{b} + \hat{c} ) - \frac{i}{2} {κ}_{c} \hat{b} {\hat{c}}^{†} + h . c . , \qquad ( 20 )$$

$${\hat{H}}_{disp .} = \frac{{κ}_{c} {e}^{r}}{4 {α}^{′}} ( \hat{a} + {\hat{a}}^{†} ) {\hat{b}}^{†} \hat{b} ,$$

where âₛ=cos h râ+sin h râ^{†} is the squeezed annihilation operator, and J:=\sqrt{Γₐκ_{c}}/2. It is assumed that κ_{c}=Γ_{b}=λ. Ĥ_{tun.} involves several cubic nonlinear couplings between the a, b modes and between the a, c modes. In addition, Ĥ_{tun.} requires a resonant linear coupling between the b, c modes and some linear drives with strength

$$\frac{J {α}^{′}}{2}$$

on the b, c modes that pump energy into the system. Note that all the nonlinear terms are cubic, which have been experimentally demonstrated in superconducting circuits. The maximum nonlinear coupling strength is Jₘ:=J sin h 2r/2α′. κ₂ may be written as a function of Jₘ and κ_{c}. Comparing the dissipator \sqrt{Γₐ}\hat{Z}_{L}⊗\tilde{â} in Eq. (19) with the dissipator \sqrt{κ₂}\hat{F}≈\sqrt{κ₂}2α′\hat{Z}_{L}⊗\tilde{â}, there is κ₂=Γₐ/4α′², so that

$${κ}_{2} = \frac{4 {J}_{m}^{2}}{{κ}_{c} {sinh}^{2} 2 r} .$$

If Γₐ=ϵ₀κ_{c} (and correspondingly,

$${κ}_{c} = \frac{4 {α}^{′} {J}_{m}}{\sqrt{{ϵ}_{0}} sinh 2 r} ) ,$$

where ϵ₀<1 is related to the adiabatic elimination condition discussed above, Jₘ=α′ sin h 2rκ₂/\sqrt{ϵ₀} is obtained.

The second approach is described for implementing the dissipator

$$\hat{F} = \frac{1}{{α}^{′}} \hat{S} ( r ) \hat{a} ( {\hat{a}}^{2} - {α}^{′2} ) {\hat{S}}^{†} ( r )$$

using a coupled boson-qutrit system. A simpler dissipator stabilizing a cat â²−α² was obtained using a coupled boson-qubit system in trapped-ion platform. However, the dissipator \hat{F} cannot be directly engineered using their approach since there are many frequency-degenerate terms, e.g., â and â^{†}â², that cannot be independently controlled by a single sideband drive. To resolve this, their approach may be generalized by introducing a third internal level of the ion, and implementing the dissipator \hat{F} in two steps associated with different electronic transitions. Specifically, the motional mode of the ions in a 1D harmonic trap may be used as the bosonic mode, which is coupled to three internal levels |g [symbol] , |e [symbol] and |f [symbol] via several laser beams:

$$\frac{d}{dt} \hat{ρ} = - i [ {\hat{H}}_{eff} , \hat{ρ} ] + 𝒥 \hat{ρ} , \qquad ( 21 )$$

$$where {\hat{H}}_{eff} = v {\hat{a}}^{†} \hat{a} + {ω}_{e} \vert e 〉 〈 e \vert + {ω}_{f} \vert f 〉 〈 f \vert + \frac{1}{2} {Ω}_{0} ( \vert f 〉 〈 g \vert {e}^{- i {ω}_{f} t} + h . c . ) + {\hat{H}}_{coup} - i \frac{Γ}{2} \vert e 〉 〈 e \vert ,$$

with

$${\hat{H}}_{coup} = {\sum }_{i = 1}^{3} {Ω}_{i} cos [ {η}_{0} ( \hat{a} + {\hat{a}}^{†} ) ] ( \vert f 〉 〈 g \vert {e}^{- i ( {ω}_{f} + {δ}_{i} ) t} + h . c . ) + {\sum }_{i = 4}^{5} {Ω}_{i} sin [ {η}_{0} ( \hat{a} + {\hat{a}}^{†} ) ] ( \vert e 〉 〈 f \vert {e}^{- i ( {ω}_{e} - {ω}_{f} + {δ}_{i} ) t} + h . c . ) , \qquad ( 22 )$$

$$and$$

$$J \hat{ρ} = Γ {\int }_{- 1}^{1} duN ( u ) {e}^{- i {η}_{0} u ( \hat{a} + {\hat{a}}^{†} )} \times \vert g 〉 〈 e \vert \hat{ρ} \vert e 〉 〈 g \vert {e}^{i {η}_{0} u ( \hat{a} + {\hat{a}}^{†} )} . \qquad ( 23 )$$

Here ν is the trap frequency, η₀ the Lamb-Dick parameter, Γ the engineered decay rate from |e [symbol] to |g [symbol] , and N(u) the normalized dipole pattern. Ĥ_{coup} describes the coupling between the motional mode and the internal states, illustrated in FIG. 10, and [symbol] \hat{ρ} describes the spontaneous emission of the ion from |e [symbol] to |g [symbol] and its associated momentum kicks. The drive with amplitude Ω₀ in Ĥ_{eff} comes from a laser that is coupled to the ion along a constrained (transverse) direction, thereby only driving the internal transitions. By tuning the laser detunings δ₁=−2ν, δ₂=2ν, δ₃=0, δ₄=−ν, and δ₅=ν, and choosing appropriate driving strength {Ωᵢ}, a coupling Hamiltonian (neglecting the fast-rotating terms) may be obtained:

$${\hat{H}}_{coup} = {Ω}_{gf}^{′} \hat{S} ( r ) ( {\hat{a}}^{2} - {α}^{′2} ) {\hat{S}}^{†} ( r ) \vert f 〉 〈 g \vert + {Ω}_{ef}^{′} \frac{1}{{α}^{′}} \hat{S} ( r ) \hat{a} {\hat{S}}^{†} ( r ) \vert e 〉 〈 f \vert + h . c . \qquad ( 24 )$$

In the regime where

$$2 {α}^{′} {Ω}_{gf}^{′} ≪ Γ , {Ω}_{gf}^{′} ≪ {Ω}_{ef}^{′} ,$$

a reduced dynamics on the motional mode may be obtained by adiabatically eliminating the |e [symbol] , |f [symbol] states:

$$\frac{d}{dt} {\hat{ρ}}_{m} = {κ}_{2} 𝒟 [ \hat{F} ] {\hat{ρ}}_{m} , \qquad ( 25 )$$

where \hat{ρ}ₘ is the reduced density matrix on the motional mode. Through numerically simulations, the dissipator \hat{F} with the desired rate may be obtained by setting

$${Ω}_{ef}^{′} = 0.5 Γ , {Ω}_{gf}^{′} / {Ω}_{ef}^{′} = 1 / 20.$$

A large κ₂, therefore, demands large Γ and driving strength. It may be assumed that Γ and {Ωᵢ}, i=1, 2, 3, 4, 5 are much smaller than ν, so that the off-resonant terms can be safely neglected (secular approximation). In practice, however, one might be able to go beyond this weak-drive regime by carefully cancelling the effects from the off-resonant terms. The effects from the momentum kicks may be ignored here, which only lead to a small increase in the phase-flip suppression factor

$$η \to η + 𝒪 ( {η}_{0}^{2} ) .$$

Some described implementations may require the same order of nonlinearity as that required by a two-component cat, which has been considered to be feasible in trapped-ion system.

### The Memory Error Rates of the Squeezed Cat

The following paragraphs describes the derivation of the memory error rates for the SC in Eqs. (10) and (11).

Since the bit-flip error rate is exponentially small in α′, the subsystem decomposition is insufficient to obtain an analytical expression of it. Thus, the bit-flip error rate may be derived using the conserved quantities of the system. To facilitate the analysis, firstly, the \hat{Z}_{L} term in the dissipator in Eq. (7) may be neglected since it does not contribute to the bit-flip rate, and then the system dynamics may be analyzed in the squeezed frame:

$$\frac{d {\hat{ρ}}_{s}}{dt} = {κ}_{2} 𝒟 [ {\hat{a}}^{2} - {α}^{′ 2} ] {\hat{ρ}}_{s} + {κ}_{ϕ} 𝒟 [ {â}_{s}^{†} {â}_{s} ] {\hat{ρ}}_{s} , \qquad ( 26 )$$

where Âₛ:=Ŝ^{†}(r)ÂŜ(r) for any operator Â. Note that the dephasing is considered here, which is the dominant source for the bit-flip errors. The two conserved quantities associated with the dominant dissipator â²−α′² are

$${\hat{J}}_{+ +} = {\sum }_{n = 0}^{∞} \vert 2 n 〉 〈 2 n \vert , \qquad ( 27 )$$

$${\hat{J}}_{+ -} = \sqrt{\frac{2 {α}^{′ 2}}{sinh 2 {α}^{′ 2}}} {\sum }_{q = - ∞}^{∞} \frac{{( - 1 )}^{q}}{2 q + 1} {I}_{q} ( {α}^{′ 2} ) {\hat{J}}_{+ -}^{( q )} ,$$

where I_{q}(·) is the modified Bessel function of the first kind, and

$${\hat{J}}_{+ -}^{( q )} = \frac{( {â}^{†} â - 1 ) !!}{( {â}^{†} â - 2 q ) !!} {\hat{J}}_{+ +} {â}^{2 q + 1}$$

for q≥0 and

$${\hat{J}}_{+ -}^{( q )} = {\hat{J}}_{+ +} {â}^{† 2 q + 1} + 1 \frac{( {â}^{†} â ) !!}{( {â}^{†} â - 2 \vert q \vert - 1 ) !!}$$

for q<0. The steady state coherence of the system initialized in \hat{ρ}(0) can be computed through

$${c}_{+ +} ( ∞ ) = tr \{ {J}_{+ +}^{†} ρ ( 0 ) \} and {c}_{+ -} ( ∞ ) = tr \{ {J}_{+ -}^{†} ρ ( 0 ) \} .$$

Thus, the bir-flip rate may be computed perturbatively by considering the dephasing in the squeezed frame,

$${γ}_{X , Y} = - {κ}_{ϕ} tr \{ {J}_{+ -}^{†} 𝒟 [ {\hat{S}}^{†} ( r ) {â}^{†} â \hat{S} ( r ) ] \vert {C}_{α}^{+} 〉 〈 {C}_{α}^{-} \vert \} , \qquad ( 28 )$$

which is then simplified to Eq. (11).

The phase-flip error rate Eq. (10) can be easily derived by analyzing the errors under the subsystem decomposition. The loss and heating errors are in the form â≈\hat{Z}_{L}⊗(e^{-r}α′+cos h r\tilde{â}−sin h r\tilde{â}^{†}), â^{†}≈\hat{Z}_{L}⊗(e^{-r}α′+cos h r\tilde{â}^{†}−sin r\tilde{â}). They both contribute to the phase-flip rate via the undetectable term e^{-r}α′\hat{Z}_{L}=\sqrt{η\hat{n}}\hat{Z}_{L} (the detectable part associated with the \hat{Z}_{L}⊗\tilde{â}^{†} term is approximately correctable by \hat{F}). The dephasing is in the form â^{†}â≈Î_{L}⊗[e^{-2r}α^{r/2}+e^{-2r}α′(\tilde{â}+\tilde{â}^{†})+cos h² r\tilde{â}^{†}\tilde{â}+sin h² r\tilde{â}\tilde{â}^{†}−cos h r sin h r (\tilde{â}²+\tilde{â}^{†2})]. It contributes to the phase-flip rate dominantly by the e^{-2r}α′Î_{L}⊗\tilde{â}^{†} term, which creates an excitation in the gauge mode that is subsequently destroyed by \hat{F} with a residual phase flip. Therefore, the dephasing contributes to the phase-flip rate by κ_{φ}e^{-4r} α′²=κ_{φ}e^{-2r}ηn̅.

Eq. (10) is valid in the regime where α′»1, which is violated when r approaches the maximum squeezing allowed by the energy constraint. A leading-order correction is provided to the loss-induced phase flip rate in such a regime. It is assumed that the dissipator \hat{F}=\hat{Z}_{L}(â²−α²)≈\hat{Z}_{L}⊗(\tilde{â}²+2α′\tilde{â}) can perfectly correct the detectable part of the loss-(or heating-)induced errors by removing the excitation in the gauge mode while applying a phase-flip correction on the logical qubit. However, it is not a perfect correction because of the non-Hermitian part of the dynamics induced by F^{†}F≈Î_{L}⊗[\tilde{â}^{†2}\tilde{â}a²+2α′(\tilde{â}^{†2}\tilde{â}^{†}\tilde{â}²)+4α′²\tilde{â}^{†}\tilde{â}]. The second term above further excites the gauge mode, which introduces additional nonnegligible Z errors when α′»1 does not hold. Through analysis of a simplified 3-level system, a correction factor for the phase-flip rate may be obtained in the form of

$$ξ = \frac{1}{2 ( 1 + 3 {α}^{′ 2} )} , \qquad ( 29 )$$

which works well for α′≥1.5. This factor represents that, if the qubit evolves from an initial state of |± [symbol] _{L}⊗|ñ=1 [symbol] under the dissipator \hat{F}, a population of 1−ξ would end up in |∓ [symbol] _{L}⊗|ñ=0 [symbol] and ξ would be in |± [symbol] _{L}⊗|ñ=0 [symbol] in steady state. Therefore, the phase-flip rate in Eq. (10) has an extra correction:

$${γ}_{Z} \to {γ}_{Z} + {κ}_{1} ( 1 + {n}_{t h} ) \overline{n} ( 1 - η ) ξ + {κ}_{1} {n}_{t h} ( 1 - {η}^{′} ) ξ - {κ}_{ϕ} {e}^{- 2 r} η ξ , \qquad ( 30 )$$

where η′=(n̅−cos h² r)/n̅, which approaches η in the large squeezing limit.

The correction factor's effect becomes significant as η approaches 0. In the limit of large n̅ and only considering the dominant loss error, the Z error rate has a minimum value

$${γ}_{Z , min} \approx \frac{\sqrt{2}}{4} {κ}_{1} .$$

Worth noticing, this minimum rate is independent of n̅. Therefore, the SC enjoys an exponential suppression of the bit-flip rate while maintaining a bounded phase-flip rate by increasing n̅, which is drastically different from the cat code or its DV counterpart, the repetition code.

### Bias-Preserving Operations for the Squeezed Cat

The following paragraphs describe the detailed design and error analysis for the Z rotation Z(θ) and the CX gate for the SC, which are representatives of bias-preserving operations [symbol] .

Similarly to the cat, the Z-axis rotation Z(θ) can be generated by a resonant linear drive

$${\hat{H}}_{Z} = \frac{θ}{4 {α}^{′} T} {e}^{r} ( \hat{a} + {\hat{a}}^{†} ) , \qquad ( 31 )$$

in the presence of the engineered dissipation in Eq. (7) for a time T. In the subsystem basis,

$${H}_{Z} \approx \frac{θ}{4 {α}^{′} T} {\hat{Z}}_{L} ⊗ ( 2 {α}^{′} + \hat{\tilde{a}} + {\hat{\tilde{a}}}^{†} ) .$$

The total phase flip error probability of the Z rotation is

$${p}_{Z} = {p}_{Z}^{NA} ( T ) + {κ}_{1} η \overline{n} T ,$$

where the second term represents the loss-induced phase flips and the first term represents the non-adiabatic errors due to the non-adiabatic excitation \hat{Z}_{L}⊗\tilde{â}^{†} in Ĥ_{Z}. Compared to the parity-preserving dissipator [symbol] [Î_{L}⊗\tilde{â}], which is used in the literature for the cat (by applying a driven two-photon dissipation), the parity-flipping dissipator \hat{F} in Eq. (7) can significantly reduce the non-adiabatic errors induced by \hat{Z}_{L}⊗\tilde{â}^{†}. The reason is that the majority of the parity flips associated with the non-adiabatic transitions can be flipped back through the application of the dissipator.

The remaining errors with a fraction ξ leads to the residual non-adiabatic error

$${p}_{Z}^{NA}$$

proportional to ξ (see the previous Methods section). Under the adiabatic limit

$$\frac{θ}{4 {α}^{′} T} ≪ 4 {κ}_{2} {α}^{′2} ,$$

the system's evolution under the dissipator \hat{F} can be approximated by the dynamics of the density matrix \hat{ρ}_{trunc} with a truncated 2-level gauge basis:

$${κ}_{2} 𝒟 [ \hat{F} ] \hat{ρ} \approx 4 {κ}_{2} {α}^{′2} ( ( 1 - ξ ) 𝒟 [ {\hat{Z}}_{L} ⊗ \hat{\tilde{a}} ] + ξ𝒟 [ {\hat{I}}_{L} ⊗ \hat{\tilde{a}} ] ) {\hat{ρ}}_{trunc} . \qquad ( 32 )$$

Performing first-order adiabatic elimination on the gauge excited state results in an effective Z error rate

$$\frac{{ξθ}^{2}}{16 {κ}_{2} {α}^{′4} T} .$$

Notice that adiabatic elimination does not capture the higher-order errors and the result only holds under the adiabatic limit. A more accurate expression can be derived through solving the ordinary differential equations of the two level system. As a result, the modified non-adiabatic error has the form:

$${p}_{Z}^{NA} ( T ) = \frac{{ξθ}^{2}}{16 {κ}_{2} {α}^{′4} {T}^{2}} ( {c}_{1} T + {c}_{2} \frac{{e}^{- 2 {κ}_{2} {α}^{′2} T} - 1}{2 {κ}_{2} {α}^{′2}} ) . \qquad ( 33 )$$

Performing numerical fit, c₁=1.5, c₂=1.8 may be obtained.

The CX gate is implemented by applying the engineered dissipation only on the control mode and a Hamiltonian term that drives a phase rotation on the target mode conditioned on the states of the control mode:

$$\frac{d}{dt} \hat{ρ} = {κ}_{2} 𝒟 [ {\hat{F}}_{c} ] \hat{ρ} - i [ {\hat{H}}_{CX} , \hat{ρ} ] , \qquad ( 34 )$$

$${\hat{H}}_{CX} = \frac{π}{4 {α}^{′} T} [ {e}^{r} ( {\hat{a}}_{c} + {\hat{a}}_{c}^{†} ) - 2 {α}^{′} ] ( {\hat{a}}_{t}^{†} {\hat{a}}_{t} - {α}^{′2} ) ,$$

where \hat{F}_{c} denotes the engineered dissipator in Eq. (7) on the control mode. The noise terms are not shown for simplicity. Compared to the standard CX gate on the cat, the dissipation on the target mode may be turned off during the gate to circumvent the need for high-order coupling terms between the two modes. Although the target mode temporarily loses the protection against the excitation loss, a high-quality gate may still be implemented if the gate time is short enough and the leakage on the target mode can be subsequently returned to the code space without introducing too many errors.

To deal with the non-adiabatic transitions on the target mode, which preserve the parity, a parity-preserving dissipation

$${κ}_{2} 𝒟 [ \hat{S} ( r ) ( {\hat{a}}_{t}^{2} - {α}^{′2} ) {\hat{S}}^{†} ( r ) ]$$

may be applied on the target mode (while the control mode is, as always, protected by the parity-flipping dissipation) for a time T_{cool}. In simulations, the cooling time

$${T}_{cool} = 8 \times \frac{1}{4 {κ}_{2} {α}^{′2}}$$

is fixed to ensure that the leakage is suppressed to below 0.5%. Using the Pauli-twirling approximation, the Z-type errors of the CX gate are

$${p}_{{Z}_{c}} = {κ}_{1} η \overline{n} ( T + {T}_{cool} ) + {p}_{Z}^{NA} ( T ) , \qquad ( 35 )$$

$${p}_{{Z}_{t}} = {κ}_{1} \overline{n} ( \frac{T}{2} + {T}_{cool} ) ,$$

$${p}_{{Z}_{c} {Z}_{t}} = \frac{1}{2} {κ}_{1} \overline{n} T ,$$

where p_{Z}_{_{c}}, p_{Z}_{ₜ} and p_{Z}_{_{c}}_{Z}_{ₜ} denote the Z error on the control, target mode and the correlated Z error, respectively. They sum to the total Z error probability

$${p}_{Z} = {κ}_{1} \overline{n} ( 1 + η ) ( T + {T}_{cool} ) + {p}_{Z}^{NA} ( T ) .$$

Note that, unlike the Z rotation, the CX gate does not enjoy a full suppression of the loss-induced errors (by a factor η) due to the lack of the engineered dissipation on the target mode during the gate. The non-adiabatic error

$${p}_{Z}^{NA} ( T )$$

on the control mode has a similar form as Eq. (33):

$${p}_{Z}^{NA} ( T ) = \frac{{ξπ}^{2}}{16 {κ}_{2} {α}^{′2} {T}^{2}} ( 1.5 T + 0.6 \frac{{e}^{- 2 {κ}_{2} {α}^{′2} T} - 1}{2 {κ}_{2} {α}^{′2}} ) \qquad ( 36 )$$

The non-Z error rate of the CX gate is described, and the CX gate has a significantly larger non-Z error rate than all other bias-preserving operations in [symbol] . The non-Z error of a cat's CX gate scales approximately as

$$1.8 \frac{{e}^{- 2 {α}^{2}}}{{α}^{2}} \frac{1}{{κ}_{2} T} .$$

For the CX gate on the SC, a similar expression

$${p}_{X , Y} = 5.57 \frac{{e}^{- 2 {α}^{′2}}}{{α}^{′2}} \frac{1}{{κ}_{2} T} , \qquad ( 37 )$$

in the regime where κ₂T>1. Note that for shorter gate time, it cannot find a simple expression for p_{X,Y} and a numerical simulation of the gate has to be performed to determine p_{X,Y}.

### Subsystem Decomposition of the Squeezed Cat

The Hilbert space of a bosonic mode [symbol] _{Cv}=span{|n [symbol] , n=0, 1, 2 . . . } may be divided into two orthogonal subspaces:

$${ℋ}_{CV} = {ℋ}_{even} ⊕ {ℋ}_{odd} ,$$

where [symbol] ₑᵥₑₙ ( [symbol] _{odd}) is the +1 (−1) eigenspace of the parity operator \hat{Π}I:=e^{-i\hat{n}π}. Since both [symbol] ₑᵥₑₙ and [symbol] _{odd} are isomorphic to [symbol] _{CV}, [symbol] _{CV} may be decomposed into two subsystems:

$${ℋ}_{CV} = {ℂ}_{L}^{2} ⊗ {ℋ}_{g} ,$$

where

$${ℂ}_{L}^{2}$$

is a Hilbert space of dimension 2 (referred as a qubit), and [symbol] _{g}≅ [symbol] _{CV} is a Hilbert space of infinite dimension (referred as a gauge mode). Under this decomposition, |+ [symbol] _{L}⊗|ψ [symbol] _{g} (|− [symbol] _{L}⊗|ψ [symbol] _{g}) is an even-(odd-) parity state for any |ψ [symbol] _{g}∈ [symbol] _{g}. The choice of the gauge mode basis is not unique. For instance, a basis may be chosen for [symbol] _{g} based on the modular decomposition of the number operator: |+ [symbol] _{L}⊗|m [symbol] _{g}:=|0+2m [symbol] (|− [symbol] _{L}⊗|m [symbol] g:=|1+2m [symbol] ). For the squeezed cat (SC), it is convenient to work with another basis related to the squeezed coherent states. Firstly, a set of non-orthonormalized states |ψ_{n,±} [symbol] := [symbol] _{n,±}Ŝ(r) [D(α′)±(−1)ⁿ\hat{D}(−α′)]|n [symbol] may be defined, where [symbol] _{n,±} is the normalization factor. States with different parity ± are orthogonal with each other. The Gram-Schmidt orthonormalization procedure then is applied to the states within each parity branch (starting from |φ_{0,±} [symbol] and then increasing n) to obtain a set of orthonormalized states {|Φ_{n,±} [symbol] }. Finally, a subsystem basis may be defined as

$${{\vert \pm 〉}_{L} ⊗ \vert \tilde{n} = n 〉}_{g} := \vert {Φ}_{n , \pm } 〉 . \qquad ( 38 )$$

The choice of this subsystem basis can describe the SC more efficiently than the fock basis since |± [symbol] _{L}⊗|ñ=0 [symbol] _{g} coincides with the SC codewords. Furthermore, the physical states of a stabilized SC usually evolve within a subspace with low excitation in the gauge mode. As such, a truncation is applied to the gauge mode and the analysis within a truncated 2d-dimensional (with d being a small integer) subspace of [symbol] _{Cv}: span{|± [symbol] _{L}⊗|ñ=n [symbol] _{g}, n=0, 1, . . . , d−1} is performed.

The states |Φ_{n,±} [symbol] are equivalent to the shifted fock basis by a global squeezing transformation. For example, the expression of the bosonic annihilation operator may be obtained by applying a squeezing transformation, where it is decomposed as â_{sf}≈\hat{Z}_{L}⊗(α+\tilde{â}), and obtain

$$\begin{matrix}\hat{a} & {\to }^{\hat{S} ( r )} & {\hat{S}}^{†} ( r ) {\hat{a}}_{sf} \hat{S} ( r ) & ( 39 ) \\ & = & cosh r {\hat{a}}_{sf} - sinh r {\hat{a}}_{sf} & ( 40 ) \\ & = & {\hat{Z}}_{L} ⊗ ( {e}^{- r} {α}^{′} + cosh r \hat{\tilde{a}} - sinh r {\hat{\tilde{a}}}^{†} ) + 𝒪 ( {e}^{- 2 {α}^{′2}} ) . & ( 41 )\end{matrix}$$

With the decomposition above,

$$\frac{1}{{α}^{′}} \hat{S} ( r ) ( {c}_{1} \hat{a} + {c}_{2} {\hat{a}}^{†} ) {\hat{S}}^{†} ( r ) = {\hat{Z}}_{L} ⊗ [ \hat{\tilde{I}} + \frac{1}{{α}^{′}} ( {c}_{1} \hat{\tilde{a}} + {c}_{2} {\hat{\tilde{a}}}^{†} ) ] + 𝒪 ( {e}^{- 2 {α}^{′2}} ) \approx {\hat{Z}}_{L} ⊗ \hat{\tilde{I}} . \qquad ( 42 )$$

Therefore, the physical dissipator indeed approximates the desired dissipator in other paragraphs in the present disclosure, under the assumption of α′>1.

### Error Correction Properties of the Squeezed Cat

With the squeezed displaced Fock states as a subsystem decomposition basis for the squeezed cat, its error correction properties may be better understood. Recall the codewords being defined as

$$\vert {SC}_{r , {α}^{′}}^{\pm } 〉 = \hat{S} ( r ) \vert {C}_{{α}^{′}}^{\pm } 〉 .$$

It is worth noticing that there exist an alternative definition of the squeezed cat code through the squeezed coherent states, |α,r [symbol] :=\hat{D}(α)Ŝ(r)|0 [symbol] . These two definitions are equivalent up to some parameter conversions such as \hat{D}(α)Ŝ(r)=Ŝ(r)\hat{D}(αe^{r}), where it may be assumed that both α and r are real. The code in the former expression is chosen for being defined because it is merely a unitary transformation on the cat code. Therefore, many tools and properties of the cat code, such as the displaced Fock basis and the dissipation gap, can be extended to the squeezed cat in a straightforward manner.

The error detection matrix of the squeezed cat is computed through

$$\begin{matrix}{\hat{P}}_{c} a {\hat{P}}_{c} & = & {α}^{′} ( \vert {SC}_{r , {α}^{′}}^{+} 〉 〈 {SC}_{r , {α}^{′}}^{-} \vert ( {q}^{- 1} cosh r - q sinh r ) + & ( 43 ) \\ & & \vert {SC}_{r , {α}^{′}}^{-} 〉 〈 {SC}_{r , {α}^{′}}^{+} \vert ( q cosh r - {q}^{- 1} sinh r ) ) & \\ & = & {α}^{′} ( {e}^{- r} \frac{q + {q}^{- 1}}{2} {\hat{Z}}_{c} + {e}^{r} \frac{q - {q}^{- 1}}{2} i {\hat{Y}}_{c} ) & ( 44 )\end{matrix}$$

where

$$q := \frac{{N}_{+}}{{N}_{-}}$$

and the normalization factors are defined as

$${N}_{\pm } = \frac{1}{\sqrt{2 ( 1 \pm {e}^{- 2 {α}^{′2}} )}} .$$

Furthermore, the average photon number of the squeezed cat is

$$\begin{matrix}\overline{n} & := & \frac{1}{2} Tr \{ {\hat{P}}_{c} \hat{n} \} & ( 45 ) \\ & = & \frac{1}{2} ( 〈 {SC}_{r , {α}^{′}}^{+} \vert \hat{n} \vert {SC}_{r , {α}^{′}}^{+} 〉 + 〈 {SC}_{r , {α}^{′}}^{-} \vert \hat{n} \vert {SC}_{r , {α}^{′}}^{-} 〉 ) & ( 46 ) \\ & = & {α}^{′2} ( coth 2 {α}^{′2} cosh 2 r - sinh 2 r ) + {sinh}^{2} r & ( 47 ) \\ & \approx & {α}^{′2} {e}^{- 2 r} + {sinh}^{2} r & ( 48 )\end{matrix}$$

where coth 2α′²≈1 is assumed. Therefore, the relation between the displacement and the squeezing may be,

$${α}^{′} \approx \sqrt{\overline{n} - {sinh}^{2} r} {e}^{r} . \qquad ( 49 )$$

$$⇒ {α}^{′2} = - \frac{1}{4} {e}^{4 r} - ( \overline{n} + \frac{1}{2} ) {e}^{2 r} - \frac{1}{4} \qquad ( 50 )$$

The above relation is plotted in FIG. 11(a). α′² is a concave quadratic function of e^{2r}, and the maximal displacement is

$${α}_{max}^{′} = \sqrt{{\overline{n}}^{2} + \overline{n}} .$$

FIG. 11(b) shows how the average photon number is varied as a function of squeezing while maintaining a constant dissipation gap, which is proportional to α′², fixed. A maximum suppression of average photon number may be achieved at an intermediate squeezing while enjoying the same protection from dissipation gap as the cat code.

### Error Channel of the Dissipatively Stabilized Squeezed Cat

This paragraph describes a more detailed analysis on the error channel of the dissipatively stabilized cat, which can be represented by the process matrix χ: ε(\hat{ρ})=Σ_{i,j∈{I,X,Y,Z}}χ_{i,j}\hat{σ}ᵢ\hat{ρ}\hat{σ}ⱼ. FIG. 12 shows a numerically obtained matrix χ for a SC with n̅=4, r=0.2 stabilized by the parity-flipping dissipator \hat{Z}_{L}Ŝ(r)(â²−α′²)Ŝ^{†}(r) under loss, heating and dephasing. Since χ has off-diagonal elements the channel is not exactly a Pauli error channel. It is generally in the form ε(\hat{ρ})=(λ_{I}Î+λ_{X}\hat{X})\hat{ρ}(λ_{I}Î+λ_{X}\hat{X})^{†}+(λ_{Y}Ŷ+λ_{Z}\hat{Z})\hat{ρ}(λ_{Y}Ŷ+λ_{Z}\hat{Z})^{†}, with coherence between Î, \hat{X} and Ŷ, \hat{Z}. The cat may have the same form of error channel. The Pauli error rates γ_{X}, γ_{Y}, γ_{Z} may refer to the diagonal elements of x, which implicitly assumes the Pauli-twirling approximation.

### Bias-Preserving Operations

The following paragraphs describe to construct the remaining bias-preserving operations in [symbol] ={ [symbol] _{X}, X, Z(θ), ZZ(θ), CNOT, Toffoli}, other than Z(θ) and CNOT.

The ZZ rotation can be implemented by applying the following beamsplitter Hamiltonian to two dissipatively stabilized modes:

$${\hat{H}}_{ZZ} = \frac{π}{4 {α}^{′2}} {e}^{2 r} ( {\hat{a}}_{1} {\hat{a}}_{2}^{†} + {\hat{a}}_{1}^{†} {\hat{a}}_{2} ) .$$

The Toffoli gate can be implemented similarly to the CX gate:

$$\frac{d}{dt} \hat{ρ} = {κ}_{2} 𝒟 [ {\hat{F}}_{{c}_{1}} ] + {κ}_{2} 𝒟 [ {\hat{F}}_{{c}_{2}} ] - i [ {\hat{H}}_{Tof} , \hat{ρ} ] ,$$

$${\hat{H}}_{Tof} = - \frac{π}{8 {α}^{′2} T} ( ( {e}^{r} {\hat{a}}_{{c}_{1}} - {α}^{′} ) ( {e}^{r} {\hat{a}}_{{c}_{2}}^{†} - {α}^{′} ) + h . c . ) \times ( {\hat{a}}_{t}^{†} {\hat{a}}_{t} - {α}^{′2} ) ,$$

where \hat{F}_{c}_{₁} and \hat{F}_{c}_{₂} are the parity-flipping dissipator on the c₁ and c₂ mode, respectively.

The X gate can be implemented by adiabatically tuning the phases of the stabilized code states

$${e}^{- i \frac{π}{T} t {\hat{a}}^{†} \hat{a}} \vert {SC}_{r , {α}^{′}}^{\pm } 〉$$

so that a π phase rotation is implemented in time T. By adding a counterdiabatic drive

$${\hat{H}}_{X} = \frac{π}{T} {\hat{a}}^{†} \hat{a}$$

the non-adiabatic effects are completely suppressed and the X gate can be implemented arbitrarily fast in principle.

To prepare the X-basis eigenstate

$$\vert S {C}_{r , {α}^{′}}^{+} 〉 ,$$

the system may be initialized into the vacuum state |0 [symbol] , and the parity-preserving dissipation κ₂ [symbol] [Ŝ(r)(â²−α′²)Ŝ^{†}(r)] may be turned on. Since the parity is a conserved quantity, the even-parity state

$$\vert {SC}_{r , {α}^{′}}^{+} 〉 ,$$

at a time t»¼κ₂α′² may be obtained. Such a process is not protected from photon losses, since the dissipation does not correct the loss-induced stochastic phase flips. The implementation of more robust state preparation against losses may be explored. One possible approach is to adiabatically inflate the SC from vacuum by tuning the dissipation (with an appropriate counter-adiabatic drive), while maintaining the phase-flip correction.

To perform an X-basis measurement, the engineered dissipation may be turned off and the standard QND bosonic parity measurement may be applied using a dispersive coupling between the bosonic mode and a transmon qubit. A single photon loss during the dispersive coupling changes the parity and leads to stochastic measurement errors with a probability that depends on when the loss jump happens. As such, the loss-induced measurement error probability associated with such a single measurement is

$${p}_{m} = \frac{1}{2} \overline{n} {κ}_{1} T .$$

To suppress the loss-induced error, the QND parity measurement may be applied three times and the parity-flipping dissipation may be applied to correct the loss after each measurement. Finally, a majority vote may be performed to obtain the measurement outcome. Such a protocol leads to a loss-induced measurement error probability

$${p}_{m}^{′} = \frac{3}{2} η {κ}_{1} \overline{n} T + 𝒪 ( {( {κ}_{1} T )}^{2} ) ,$$

which maintains the η suppression factor against photon loss.

### Details of the Concatenated Quantum Error Correction

The following paragraphs describe the details of the concatenated QEC with the SC qubits. The physical error rates of the SC used in some other figure are shown in Table 2. n̅=4, η=0.25 (r=1.32) may be fixed for all the operations. The idling time depends on the specific location in a QEC cycle (idling during the ancilla readout and initialization, idling during gate operations on other data qubits, etc.). The same state preparation time may be used to make sure that the leakage is below 10⁻³. It is assumed that the X-basis measurement has negligible contribution to the QEC cycle time, given that the swap between the ancilla mode and the readout mode can be implemented much faster than all the other operations and the time-consuming repeated parity measurements on the readout mode can be performed in parallel with the QEC cycle. Furthermore, it is numerically observed that both the surface code and the repetition code have a high tolerance against ancilla measurement errors. Their logical error rates are almost unaffected for measurement errors up to 10⁻². So the Z error rates from [symbol] _{X} may be neglected as well. Referring to Table 2, for repetition code, it works under the long gate time regime, and for κ₁/κ₂>10⁻³, the optimal gate time is numerically found to be limited by the constraint, i.e.

$$T = \frac{1}{{κ}_{2}} .$$

For surface code, the optimal gate time is obtained through first principle simulations, denoted as T*. All quantities that are neglected in the simulations are labelled as ≈. p_{X,Y} denotes the total probability of all non-dephasing errors. p_{X,Y} of the CX gate in the surface-code simulation is not used. The same QEC circuits and decoders (minimum-weight-perfect-matching decoder) may be used for both the thin surface code and the repetition code.

TABLE 2
For CX gates, repetition code and surface code assumes
different constraints and regimes.

| | | | | | CX (surface |
|---|---|---|---|---|---|
| Operation | Idling | [symbol] | [symbol] _{X} | CX (rep code) | code) |
| η | 0.25 | 0.25 | 0.25 | 0.25 | 0.25 |
| Gate time | T | $10 * \frac{1}{{κ}_{2} {α}^{′2}}$ | ≈ 0 | 1/κ₂ | T* |
| p_{Z} | κ₁ηn̅T | $\frac{10 \tilde{n}}{{α}^{′2}} \frac{{κ}_{1}}{{κ}_{2}}$ | ≈ 0 | $\approx ( 1 + η ) \tilde{n} \frac{{κ}_{1}}{{κ}_{2}}$ | $0.44 {( \frac{{κ}_{1}}{{κ}_{2}} )}^{2 / 3}$ |
| p_{X,Y} | ≈ 0 | 0 | 0 | $5.57 \frac{{e}^{- 2 {α}^{′2}}}{{α}^{′2}}$ | / |

For surface code simulations, the logical error rates varying with physical error rate ratio κ₁/κ₂ and threshold may be a function of average photon number in κ₁/κ₂ in FIG. 8 (a, b). The optimal CX gate time for certain κ₁/κ₂ may be numerically obtained, assuming a fixed cooling time T_{cool}. When the total Z error is optimal, it is observed that the Z-error components can be described by similar relations of

$${p}_{Z}^{o p t} ∝ {( \frac{{κ}_{1}}{{κ}_{2}} )}^{2 / 3} .$$

With these expressions for each Z error component, circuit level simulations with Stim may be performed to obtain logical error rates and estimations of thresholds at varying physical error ratios. FIG. 8(b) includes thresholds for conventional cat encoding, where the optimal Z error is independent of the physical error ratio.

The repetition code simulation focuses on the logical error rates and the minimal logical errors achievable, as shown in FIG. 8 (c, d). For the logical error rates, the simulations are similar to surface code ones. The difference arise in the minimal logical error simulations, where the long gate time constraint is imposed. The constraint is primarily imposed such that the non-dephasing error rate of the CX gate can be expressed as

$${p}_{X , Y} \approx 5.57 \times \frac{{e}^{- 2 {α}^{′ 2}}}{{α}^{′ 2}} \frac{1}{{κ}_{2} T} .$$

In this regime, the Z error is dominated by loss-induced error, which is linear in κ₁/κ₂. The optimal gate time for ratios larger then ~10⁻³, is limited by this constraint. Similarly, minimal error rates for cat encoding may be included, with the non-dephasing error rate expression of CX gate and Z logical error rates of repetition code.
Embodiments with Physical Implementations

As discussed in some other paragraphs in the present disclosure, the desired nonlinear dissipator [symbol] [\hat{F}] with \hat{F}∝\hat{Z}_{L}Ŝ(r)(â²−α′²)Ŝ^{†}(r) can be realized via two distinct approaches, each involving nonlinear interactions that are more compatible with circuit QED systems, or trapped ion systems, respectively. Below, more details for the relevant physical implementations are described.

### Implementation in Superconducting Circuit Systems

### Derivations of Adiabatic Elimination and Error Analysis

Physical implementation via two auxiliary modes b and c are considered, so that the total system dynamics can be described by the following master equation

$$\frac{d}{d t} \hat{ρ} = - i [ \frac{λ}{2} {\hat{Z}}_{L} {\hat{b}}^{†} \hat{b} + ( {J}_{a b} {\hat{\tilde{a}}}^{†} \hat{b} + ( {J}_{a c} \hat{\tilde{a}} - {iJ}_{b c} \hat{b} ) {\hat{c}}^{†} + h . c . ) , \hat{ρ} ] + {κ}_{c} 𝒟 [ \hat{c} ] , \qquad ( 51 )$$

where the corresponding tunnel coupling rates are given by

$${J}_{a b} = \sqrt{{Γ}_{a} {Γ}_{b}} / 2 , {J}_{a c} = \sqrt{{Γ}_{a} {κ}_{c}} / 2 , {J}_{b c} = \sqrt{{Γ}_{b} {κ}_{c}} / 2. \qquad ( 52 )$$

The regime where modes b and c effectively serve as a Markovian reservoir for the composite system consisting of logical qubit and the gauge mode degrees of freedom may be of interest. In what follows, it is first shown how the desired system dissipator emerges following a standard adiabatic elimination procedure and assuming the relevant parameters are chosen such that the adiabatic approximation is valid. Then the steady state dynamics of Eq. (51) under initial state with a single excitation in the gauge mode may be exactly solved, and that analytical solution to quantitatively derive the conditions on the physical parameters to be in the adiabatic regime may be used, as well as the dominating error rate introduced by Eq. (51).

Following the convention, the ground and excited manifolds are identified as the joint vacuum, and the excited state subspace of auxiliary modes b and c, respectively. The total system dynamics in Eq. (51) may be separated into contributions describing the ground (excited) state Hamiltonian Ĥ_{g} (Ĥₑ), the perturbative excitation (relaxation) coupling operator \hat{V}₊ (\hat{V}₋), as well as the decay jump operator \hat{L}ₗₒₛₛ as

$${\hat{H}}_{g} = 0 , {\hat{H}}_{e} = \frac{λ}{2} {\hat{Z}}_{L} {\hat{b}}^{†} \hat{b} + i \frac{\sqrt{{Γ}_{b} {κ}_{c}}}{2} ( {\hat{b}}^{†} \hat{c} - {\hat{c}}^{†} \hat{b} ) , \qquad ( 53 )$$

$${\hat{V}}_{-} = {\hat{V}}_{+}^{†} = \frac{\sqrt{{Γ}_{a}}}{2} {\hat{\tilde{a}}}^{†} ( \sqrt{{Γ}_{b}} \hat{b} + \sqrt{{κ}_{c}} \hat{c} ) , {\hat{L}}_{loss} = \sqrt{{κ}_{c}} \hat{c} . \qquad ( 54 )$$

The dissipation in Eq. (51) only involves a relaxation process from the excited to the ground manifold, the general formulas may be directly applied to adiabatically eliminate the auxiliary modes and obtain an effective quantum master equation involving \hat{Z}_{L} and \tilde{â}. More specifically, the effective non-Hermitian Hamiltonian governing subspace with a single excitation in modes b or c can be written as

$$\begin{matrix}{\hat{H}}_{NH} = {\hat{H}}_{e} - \frac{i}{2} {\hat{L}}_{loss}^{†} {\hat{L}}_{loss} & ( 55 ) \\ = \frac{λ}{2} {\hat{Z}}_{L} \vert {1}_{b} 〉 〈 {1}_{b} \vert + i \frac{\sqrt{{Γ}_{b} {κ}_{c}}}{2} ( \vert {1}_{b} 〉 〈 {1}_{c} \vert - h . c . ) - i \frac{{κ}_{c}}{2} \vert {1}_{c} 〉 〈 {1}_{c} \vert , & ( 56 )\end{matrix}$$

so that the effective ground-state manifold system Hamiltonian is obtained Ĥ_{eff}, and the jump operator \hat{L}_{eff} as

$${\hat{H}}_{eff} - {\hat{H}}_{g} - \frac{1}{2} {\hat{V}}_{-} [ {\hat{H}}_{NH}^{- 1} + {( {\hat{H}}_{NH}^{- 1} )}^{†} ] {\hat{V}}_{+}^{†} = 0 , \qquad ( 57 )$$

$${\hat{L}}_{eff} = {\hat{L}}_{loss} {\hat{H}}_{N H}^{- 1} {\hat{V}}_{+} = i \sqrt{{Γ}_{a}} \hat{\tilde{a}} \frac{i λ {\hat{Z}}_{L} - {Γ}_{b}}{i λ {\hat{Z}}_{L} + {Γ}_{b}} . \qquad ( 58 )$$

For the purpose of analyzing the dominating error due to finite decay rate κ_{c} of the auxiliary reservoir mode c, the logical qubit operator \hat{Z}_{L} may be viewed as a qubit Pauli operator, and the gauge mode operator \tilde{â} may be viewed as the lowering operator of a genuine bosonic mode. This treatment is valid in the relevant parameter regime of interest. In such case, the long-time evolution of a generic initial state with a single excitation in the gauge mode ã and vacuum in the auxiliary modes b and c may be exactly derived, which can be fully captured by the coherence function \hat{Σ}_{L-} (i.e. off-diagonal density matrix element with respect to eigenbasis of \hat{Z}_{L}), as

$${lim}_{t \to ∞} \frac{〈 {\hat{\sum }}_{L} - ( t ) ) 〉}{〈 {\hat{\sum }}_{L} - ( 0 ) ) 〉} = {( \frac{{Γ}_{b} - i λ}{{Γ}_{b} + i λ} )}^{2} \frac{1 + \frac{{Γ}_{a} {κ}_{c} ( {Γ}_{b} + i λ )}{( {κ}_{c} + i λ ) {( {Γ}_{b} - i λ )}^{2}}}{1 + \frac{{Γ}_{a} ( {κ}_{c}^{2} + i {Γ}_{b} λ )}{{κ}_{c} ( {κ}_{c} + i λ ) ( {Γ}_{b} + i λ )}} . \qquad ( 59 )$$

To realize the desired dissipator, Γ_{b}=λ is set. From Eq. (59), it is straightforward to see that the conditions for validity of adiabatic elimination can be written as

$$\sqrt{{Γ}_{a} {Γ}_{b}} << {κ}_{c} , {Γ}_{a} ≪ {Γ}_{b} , {Γ}_{a} ≪ {κ}_{c} . \qquad ( 60 )$$

It is interesting to note that the adiabatic elimination does not require the two reservoir modes' decay rates to satisfy a hierarchy, i.e. Γ_{b}«κ_{c}. This might seem surprising at the first glance, as Eq. (51) is motivated based on the intuition that mode c is lossy and enables a directional coupling from a to b. However, from the perspective of doing adiabatic approximation, it only need to ensure that the excitation exchange between system (logical qubit and gauge mode) and the auxiliary modes is much slower than the internal reservoir dynamics of b and c, which also leads to Eq. (60).

In current superconducting circuit implementations, one of the relevant factors limiting the strength Γₐ of effective dissipation is the finite bandwidth of the auxiliary reservoir κ_{c}. For convenience, Eq. (60) may be rewritten as follows

$${Γ}_{a} ≪ min \{ {Γ}_{b} , {κ}_{c} , {κ}_{c}^{2} / {Γ}_{b} \} . \qquad ( 61 )$$

One can thus show that for a fixed value of κ_{c}, the optimal choice of Γ_{b} to maximize the effective dissipation strength Γₐ is Γ_{b}=κ_{c}, in which case κ_{c}=Γ_{b}=λ. Substituting this expression into Eq. (59), the leading-order error rate to the logical qubit coherence function can be in turn derived as

$${lim}_{t \to ∞} \frac{〈 {\hat{\sum }}_{L -} ( t ) 〉}{〈 {\sum }_{L -} ( 0 ) 〉} ≃ {( \frac{{Γ}_{b} - i λ}{{Γ}_{b} + i λ} )}^{2} ( 1 - \frac{{Γ}_{a}}{2 {Γ}_{b}} ) . \qquad ( 62 )$$

Thus, the relation between ideal Z-error rate may be recovered assuming a perfect dissipator [symbol] [\hat{F}], versus the simulated error rate via the discussed physical implementation, as ηₛᵢₘ−η_{pred}=(1−η_{pred}) (Γₐ/2Γ₆).

### Experimental Parameters

The involved physical nonlinear terms in Eq. (51) and their strengths and required pump frequencies are described in Table 3. For large squeezing, the optomechanics-type coupling terms â^{†}â(\hat{b}+\hat{b}^{†}) and â^{†}â(ĉ+ĉ^{†}) have the largest nonlinear coupling strength, which is denoted as Jₘ. Jₘ relates to the engineered dissipation rate κ₂ as Jₘ=α′ sin h 2rκ₂/\sqrt{ϵ₀}, where ϵ₀<1 is the constant related to the adiabatic elimination condition. The optomechanics-type couplings require driving the nonlinear element (e.g., the ATS) at the frequency of the a, b, or c modes, which could lead to linear displacements of the individual modes. However, such displacements can be compensated by directly driving the individual modes. The achievable engineered dissipation rate may be roughly estimated given constrained nonlinear coupling strengths. For realistic parameters such as Jₘ/2π=1 MHz, n̅=4, ϵ₀= 1/10, and r=1.15 (corresponding to η=½), κ₂/2π≈15 kHz may be obtained, which is already much higher than typical single-photon loss rate κ₁.

TABLE 3
The nonlinear terms involved in the described scheme,
their strengths, and the required pump frequencies.

| | | Required pump |
|---|---|---|
| Nonlinear terms | Strength | frequency |
| â^{†2}\hat{b} + h.c. | Jₘ/2 tanh r | 2ωₐ − ω_{b} |
| â^{†2}ĉ + h.c. | Jₘ/2 tanh r | 2ωₐ − ω_{c} |
| â²\hat{b} + h.c. | Jₘ tanh r/2 | 2ωₐ + ω_{b} |
| â²ĉ + h.c. | Jₘ tanh r/2 | 2ωₐ + ω_{c} |
| â^{†}â(\hat{b} + \hat{b}^{†}) | Jₘ | ω_{b} |
| â^{†}â(ĉ + ĉ^{†}) | Jₘ | ω_{c} |
| \hat{b}^{†}\hat{b}(â + â^{†}) | Jₘe^{r}/ | ωₐ |
| | sinh 2r \sqrt{∈₀} | |

### Implementation in Trapped-Ion System

FIG. 10 describes the level scheme and laser configurations to the coupling Hamiltonians to implement the SC in trapped-ion systems. The setup involves the motional mode of the ion with Fock states |n [symbol] which is coupled to three internal states labeled |g [symbol] , |e [symbol] , |f [symbol] . Starting from the atomic ground state |g [symbol] , the system goes through a two-step coherent transition |g [symbol] →|f [symbol] →|e [symbol] with relevant driving lasers indicated by black and green arrows, respectively. In the first step, a laser drives the atomic transition |g [symbol] ⊗|n [symbol] →|f [symbol] ⊗|n [symbol] and the frequency-resolved second motional sidebands |g [symbol] ⊗|n→|f [symbol] ⊗|n±2), while the second step couples coherently |f [symbol] ⊗|n [symbol] →|e [symbol] [symbol] ⊗|n±1 [symbol] . Finally, state |e [symbol] is assumed to decay back to the ground state |g [symbol] via spontaneous emission. The effective dissipator acting on the motional state is obtained via adiabatic elimination of states |e [symbol] , |f [symbol] . The technical details of such a protocol is described below.

Neglecting the momentum kicks first, the system dynamics is described by:

$$\frac{d}{dt} \hat{ρ} = - i [ \hat{H} , \hat{ρ} ] + Γ 𝒟 [ \vert g 〉 〈 e \vert ] \hat{ρ} \qquad ( 63 )$$

$$\hat{H} = {Ω}_{0} ( \vert f 〉 〈 g \vert + \vert g 〉 〈 f \vert ) + {\sum }_{i = 1}^{3} \frac{1}{2} {Ω}_{i} {cos}^{{η}_{0} ( \hat{a} {e}^{- ivt} + {\hat{a}}^{†} {e}^{ivt} )} ( \vert f 〉 〈 g \vert {e}^{- {iδ}_{i} t} + \vert g 〉 〈 f \vert {e}^{{iδ}_{i} t} ) + {\sum }_{i = 4}^{5} \frac{1}{2} {Ω}_{i} {sin}^{{η}_{0} ( \hat{a} {e}^{- ivt} + {\hat{a}}^{†} {e}^{ivt} )} ( \vert e 〉 〈 f \vert {e}^{- {iδ}_{i} t} + \vert f 〉 〈 e \vert {e}^{{iδ}_{i} t} )$$

By choosing δ₁=−2ν, δ₂=2ν, δ₃=0, δ₄=−ν, δ₅=ν and neglecting the fast-rotating terms, the below is obtained:

$$\hat{H} = [ {ϵ}_{1} {\hat{a}}^{2} + {ϵ}_{2} {\hat{a}}^{†2} + {ϵ}_{3} ( {\hat{a}}^{†} \hat{a} + \hat{a} {\hat{a}}^{†} ) + {ϵ}_{0} ] \vert f 〉 〈 g \vert + ( {ϵ}_{4} \hat{a} + {ϵ}_{5} {\hat{a}}^{†} ) \vert e 〉 〈 f \vert + h . c . , \qquad ( 64 )$$

$$where {ϵ}_{1} = - \frac{1}{4} {η}_{0}^{2} {Ω}_{1} , {ϵ}_{2} = - \frac{1}{4} {η}_{0}^{2} {Ω}_{2} , {ϵ}_{3} = - \frac{1}{4} {η}_{0}^{2} {Ω}_{3} , {ϵ}_{0} = \frac{1}{2} ( {Ω}_{0} + {Ω}_{3} ) , {ϵ}_{4} = \frac{1}{2} {η}_{0} {Ω}_{4} , {ϵ}_{5} = \frac{1}{2} {η}_{0} {Ω}_{5} .$$

$$By setting {ϵ}_{1} = {cosh}^{2} r {Ω}_{gf}^{′} , {ϵ}_{2} = {sinh}^{2} r {Ω}_{gf}^{′} , {ϵ}_{3} = sinh r cosh r {Ω}_{gf}^{′} , {ϵ}_{0} = - {α}^{′2} {Ω}_{gf}^{′} , {ϵ}_{4} = \frac{cosh r}{{α}^{′}} {Ω}_{ef}^{′} , {ϵ}_{5} = \frac{sinh r}{{α}^{′}} {Ω}_{ef}^{′} ,$$

the below is obtained

$$\hat{H} = {Ω}_{gf}^{′} [ \hat{S} ( r ) ( {\hat{a}}^{2} - {α}^{′2} ) {\hat{S}}^{†} ( r ) ] \vert f 〉 〈 g \vert + {Ω}_{ef}^{′} \frac{1}{{α}^{′}} \hat{S} ( r ) \hat{a} {\hat{S}}^{†} ( r ) \vert e 〉 〈 f \vert + h . c . \qquad ( 65 )$$

In the adiabatic regime

$$2 {α}^{′} {Ω}_{gf}^{′} ≪ Γ , {Ω}_{gf}^{′} ≪ {Ω}_{ef}^{′} ,$$

a reduced dynamics on the motional mode may be obtained by adiabatically eliminating the |e [symbol] , |f [symbol] states:

$$\frac{d}{dt} {\hat{ρ}}_{m} = {κ}_{2} 𝒟 [ \hat{F} ] {\hat{ρ}}_{m} , \qquad ( 66 )$$

where

$${κ}_{2} = {( \frac{{Ω}_{gf}^{′}}{{Ω}_{ef}^{′}} )}^{2} Γ .$$

Numerically it is found that the dissipator \hat{F} with the desired rate may be obtained by setting

$${Ω}_{ef}^{′} = 0.5 Γ , {Ω}_{gf}^{′} / {Ω}_{ef}^{′} = 1 / 20.$$

The leading-order off-resonant term of Ĥ is

$$\frac{1}{2} ( {Ω}_{1} {e}^{2 ivt} + {Ω}_{2} {e}^{- 2 ivt} ) \vert f 〉 〈 g \vert + h . c . ,$$

which leads to AC stark shift of the gf transition frequency. One can compensate this term by adjusting the laser detuning w.r.t ω_{f}, or add a compensation drive to the bare gf transition. A rough estimate of the achievable engineered dissipation strength κ₂ may be provided based on attainable experimental parameters ν=30 MHz, η₀=0.15. With the leading-order off-resonant term compensated, a good stabilization for a Γ up to 200 KHz may be obtained, which leads to κ₂=0.5 KHz. This estimated rate is much larger than the typical ambient noise rates of the ions, which are in the level of 10 Hz. The prominent noise in many trapped-ion platforms was identified as the dephasing, which, compared to the loss errors, can be better suppressed by the SC.

A brief analysis on the effect of the momentum kicks is described. In the Lamb-Dick regime (η₀«1), the system dynamics that include the leading-order contribution from the momentum kicks read:

$$\frac{d}{dt} \hat{ρ} = - i [ \hat{H} , \hat{ρ} ] + Γ 𝒟 [ \vert g 〉 〈 e \vert ] \hat{ρ} + ( Γ {η}_{0}^{2} {\int }_{- 1}^{1} {u}^{2} N ( u ) du ) 𝒟 [ \hat{a} + {\hat{a}}^{†} ] \vert g 〉 〈 e \vert \hat{ρ} \vert e 〉 〈 g \vert . \qquad ( 67 )$$

The third term, which results from the momentum kicks, leads to extra phase flips of the SC when the ion decays from |e [symbol] to |g [symbol] . As such, the third term competes with the second term when correcting the errors on the motional mode that induce the internal-state transition cycle |g [symbol] →|f [symbol] →|e [symbol] →|g [symbol] . Fortunately, the rate of the third term is suppressed by

$${η}_{0}^{2} .$$

So the momentum kicks only read to a small increase of the phase-flip suppression factor

$$η \to η + 𝒪 ( {η}_{0}^{2} ) .$$

The present disclosure describes a trapped-ion platform. The sideband conditions may be resolved, i.e. the decay rate of |e [symbol] is assumed smaller than the trap frequency. Such a tunable engineered effective spontaneous transition rate can be engineered via Raman processes as optical pumping.

The scheme for trapped ion may be described in context of implementation of trapped-ion quantum computing for the case of ⁴⁰Ca⁺ ions. The mapping of the level scheme |g [symbol] , |e [symbol] , |f [symbol] and laser configuration to levels of the Ca⁺ ion may be described, as available in these experiment. ⁴⁰Ca⁺ has an electronic ground state ²S_{1/2} coupled via a quadrupole transition to metastable excited states ²D_{5/2,3/2}, and both the ground and metastable states can excite the short-lived ²P_{3/2,1/2} states in dipole-allowed transitions.

A first mapping is obtained by identifying |g [symbol] , |e [symbol] , |f [symbol] with long-lived states ²S_{1/2}, ²D_{5/2}, and ²D_{3/2}, respectively, where the first transition (black arrows in FIG. 10) corresponds to the quadrupole transition, while the second step (green arrows in FIG. 10) can be implemented as a Raman transition coupling the two metastable D-states. A tunable effective decay rate back to the S-ground state can be obtained as an optical pumping process via the short-lived P states.

A second mapping identifies the two Zeeman ground states |²S_{1/2} m=±½ [symbol] with levels |g [symbol] , |f [symbol] and drives the second order sidebands, as familiar from sideband cooling utilizing Raman cooling via intermediate P-states. The second coherent step can then be implemented via transitions to D-states, followed by engineered decay via short-lived P-states.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

What is claimed:

1. A method for performing a quantum operation on a qubit using an autonomous quantum error correction scheme, the method comprising:
obtaining the qubit comprising a squeezed cat (SC) qubit encoded with quantum information;
concatenating the qubit with a set of codes;
engineering a dissipation corresponding to the concatenated qubit; and
applying, according to the engineered dissipation, quantum error correction on the concatenated qubit to perform error correction on the encoded quantum information.

2. The method according to claim 1, further comprising:
applying a squeezing operation on a Schrodinger Cat qubit according to a squeezing parameter to obtain the SC qubit, a Schrodinger Cat qubit comprising coherent quantum superposition of a plurality of quantum states.

3. The method according to claim 1, wherein:
the SC qubit has an average photon number corresponding to the squeezing parameter.

4. The method according to claim 1, further comprising:
determining the squeezing parameter as so to maintain a dissipation ratio not being larger than a threshold, the dissipation ratio being a ratio between the engineered dissipation and a photon loss dissipation.

5. The method according to claim 1, wherein:
the set of codes comprises at least one outer discrete-variable code.

6. The method according to claim 5, wherein:
the outer discrete-variable code comprises at least one surface code or at least one repetition code.

7. The method according to claim 1, wherein, the engineering the dissipation corresponding to the concatenated qubit comprises:
engineering the dissipator corresponding to the concatenated qubit based on three nonlinearly-coupled bosonic modes.

8. The method according to claim 7, wherein:
the three nonlinearly-coupled bosonic modes are within superconducting circuits.

9. The method according to claim 1, wherein, the engineering the dissipation corresponding to the concatenated qubit comprises:
engineering the dissipator corresponding to the concatenated qubit based on nonlinearly coupling a bosonic mode to a qutrit.

10. The method according to claim 9, wherein:
the bosonic mode and the qutrit are in trapped-ion systems.

11. An apparatus for performing quantum computing, the apparatus comprising a first device storing a qubit and a second device performing an operation on the qubit, wherein the apparatus is configured to perform:
obtaining the qubit comprising a squeezed cat (SC) qubit encoded with quantum information;
concatenating the qubit with a set of codes;
engineering a dissipation corresponding to the concatenated qubit; and
applying, according to the engineered dissipation, quantum error correction on the concatenated qubit to perform error correction on the encoded quantum information.

12. The apparatus according to claim 11, wherein the apparatus is configured to further perform:
applying a squeezing operation on a Schrodinger Cat qubit according to a squeezing parameter to obtain the SC qubit, a Schrodinger Cat qubit comprising coherent quantum superposition of a plurality of quantum states.

13. The apparatus according to claim 11, wherein:
the SC qubit has an average photon number corresponding to the squeezing parameter.

14. The apparatus according to claim 11, wherein the apparatus is configured to further perform:
determining the squeezing parameter as so to maintain a dissipation ratio not being larger than a threshold, the dissipation ratio being a ratio between the engineered dissipation and a photon loss dissipation.

15. The apparatus according to claim 11, wherein:
the set of codes comprises at least one outer discrete-variable code.

16. A non-transitory computer-readable medium storing instructions, wherein, the instructions, when executed by a processor, are configured to cause the processor to perform:
obtaining a qubit comprising a squeezed cat (SC) qubit encoded with quantum information;
concatenating the qubit with a set of codes;
engineering a dissipation corresponding to the concatenated qubit; and
applying, according to the engineered dissipation, quantum error correction on the concatenated qubit to perform error correction on the encoded quantum information.

17. The non-transitory computer-readable medium according to claim 16, wherein, the instructions, when executed by the processor, are configured to cause the processor to further perform:
applying a squeezing operation on a Schrodinger Cat qubit according to a squeezing parameter to obtain the SC qubit, a Schrodinger Cat qubit comprising coherent quantum superposition of a plurality of quantum states.

18. The non-transitory computer-readable medium according to claim 16, wherein:
the SC qubit has an average photon number corresponding to the squeezing parameter.

19. The non-transitory computer-readable medium according to claim 16, wherein, the instructions, when executed by the processor, are configured to cause the processor to further perform:
determining the squeezing parameter as so to maintain a dissipation ratio not being larger than a threshold, the dissipation ratio being a ratio between the engineered dissipation and a photon loss dissipation.

20. The non-transitory computer-readable medium according to claim 16, wherein:
the set of codes comprises at least one outer discrete-variable code.
